(19) United States
(12) Patent Application Publication
(10) Pub. No.: US 2013/0054844 A1
(43) Pub. Date: Feb. 28, 2013

(54) INFORMATION MANAGEMENT SYSTEM AND INFORMATION PROCESSING APPARATUS

(71) Applicant: Kenji KAWASUMI, Kanagawa (JP)

(72) Inventor: Kenji KAWASUMI, Kanagawa (JP)

(73) Assignee: RICOH COMPANY LTD.

(21) Appl. No.: 13/589,384

(22) Filed: Aug. 20, 2012

(30) Foreign Application Priority Data
Aug. 23, 2011 (JP) 2011-181566
Aug. 2, 2012 (JP) 2012-171957

(51) Int. Cl. G06F 3/00

(52) U.S. Cl. 710/19

(57) ABSTRACT

An information management system includes: a first storage unit to retain history information, acquired from an electronic apparatus, indicating use history of the electronic apparatus, and a second storage unit to retain transition information indicating transition of an operation environment of the electronic apparatus in an installation site of the electronic apparatus; and an information processing apparatus to output a report indicating a use status of the electronic apparatus. The information processing apparatus includes: an acquisition part to acquire said transition information from the second storage unit and acquire said history information from the first storage unit; a creation part to create report data which aggregates apparatus use status for each affiliation area to which the electronic belongs during a designated report period based on the transition information and the history information; and an output part to output the report data created by the creation part.

### BACKGROUND OF THE INVENTION

1. Field of the Invention

The present invention relates to a technique to execute a report processing in a system to manage electronic apparatuses.

2. Description of the Related Art

In an information management service provided by an apparatus manufacturer to a customer, it is important to visualize a use status (operation rate) of an electronic apparatus installed at a customer's site in order to make a suggestion regarding environmental improvement aiming an improvement in use efficiency and a reduction in a total cost of ownership (TCO).

Thus, it is suggested to use a technique to output a tabulated report based on apparatus information acquired from apparatuses operated in a customer environment. For Example, Japanese Laid-Open Patent Application No. 2010-117898 discloses a technique to output a tabulated report in which changes in users of electronic apparatuses due to an organizational change and a personnel relocation is reflected.

However, such a conventional method is not capable of outputting an accurate tabulated report in which a configuration change of electronic apparatuses in a customer environment is reflected. In information management services, there may be a case in which an electronic apparatus manufacturer make a suggestion to a customer to change an apparatus configuration, such as an apparatus installation, an apparatus relocation, an apparatus replacement and an apparatus removal, for the purpose of improving a use efficiency of the electronic apparatuses and reducing TCO. In such a case, it is important to visualize an improvement effect according to a configuration change of the electronic apparatuses. Accordingly, it is desirable to output an accurate tabulated report in which a configuration change of electronic apparatuses is reflected.

### SUMMARY OF THE INVENTION

It is a general object of the present invention to provide an information management system in which the above-mentioned problems in the conventional methods are eliminated.

A more specific object of the present invention is to provide an information management system which is capable of outputting an aggregation report in which a configuration change of an electronic apparatus in a customer environment is reflected.

There is provided according to one aspect of the invention an information management system including: a first storage unit configured to retain history information, which is acquired from an electronic apparatus, indicating use history of the electronic apparatus; a second storage unit configured to retain transition information indicating transition of an operation environment of the electronic apparatus in an installation site of the electronic apparatus; and an information processing apparatus configured to output a report indicating a use status of the electronic apparatus, wherein the first storage unit, said second storage unit and the information processing apparatus are mutually connected through a data transmission path, and wherein the information processing apparatus includes: an acquisition part configured to acquire the transition information from the second storage unit and acquire the history information from the first storage unit; a creation part configured to create report data which aggregates apparatus use status for each affiliation area to which the electronic belongs during a designated report period based on the transition information and the history information; and an output part configured to output the report data created by the creation part.

There is provided according to another aspect of the invention an information processing apparatus configured to output information indicating use status of an apparatus, including: an acquisition part configured to acquire transition information and history information, the transition information indicating a transition of an operating environment of the apparatus with respect contents specified in a contract, the history information indicating use history of the apparatus; a creation part configured to create aggregation information indicating use status of the apparatus in a designated report period based on the transition information and the history information; and an output part configured to output the aggregation information created by the creation part.

There is provided a further aspect of the invention a non-transitory computer readable recording medium storing a report processing program causing a computer to perform as an information processing apparatus for outputting information indicating use status of an apparatus, the report processing program causing said computer to execute: an acquisition procedure to acquire transition information and history information, the transition information indicating a transition of an operating environment of the apparatus with respect contents specified in a contract, the history information indicating use history of the apparatus; a creation procedure to create aggregation information indicating use status of the apparatus in a designated report period based on the transition information and said history information; and an output procedure to output the aggregation information created by said creation part.

According to the present invention, there is provided an information management system which is capable of outputting an aggregation report in which a configuration change of an electronic apparatus in a customer environment is reflected.

Other objects, features and advantages of the present invention will become more apparent from the following detailed description when read in conjunction with the accompanying drawings.

### BRIEF DESCRIPTION OF THE DRAWINGS

FIG. 1 is a block diagram illustrating a structure of an information management system according to a first embodiment of the present invention;

FIG. 2 is a block diagram illustrating a hardware structure of a report processing apparatus (information processing apparatus) according to the first embodiment of the present invention;

FIGS. 3A, 3B and 3C are illustrations indicating an example of a report output;

FIG. 4 is a block diagram illustrating a report processing function according to the first embodiment of the present invention;

FIG. 5 is an illustration indicating an example of data of log management information according to the first embodiment of the present invention;

FIG. 6 is an illustration indicating an example of data of affiliation change history management information according to the first embodiment of the present invention;

FIG. 7 is an illustration of an example of data of apparatus management information according to the first embodiment of the present invention;

FIG. 8 is a flowchart of a first example of information management processing procedure according to the first embodiment of the present invention;

FIG. 9 is a flowchart of a second example of the information management processing procedure according to the first embodiment of the present invention;

FIG. 10 is a flowchart of a third example of the information management processing procedure according to the first embodiment of the present invention;

FIG. 11 is a flowchart of a report output processing procedure according to the first embodiment of the present invention;

FIG. 12A is an illustration of an example of a data aggregation in the above-mentioned case;

FIG. 12B is an illustration of a report output based on a result of aggregation;

FIG. 13 is a block diagram illustrating a first example of the structure of the information management system according to a variation the first embodiment of the present invention;

FIG. 14 is a block diagram illustrating the structure of the report processing function according to the variation of the first embodiment of the present invention;

FIG. 15 is an illustration of an example data of affiliation management information according to the variation of the first embodiment of the present invention;

FIG. 16 is a flowchart of a first example of an information management processing procedure according to the variation of the first embodiment of the present invention;

FIGS. 17A and 17B are flowcharts of a second example of the information management processing procedure according to the variation of the first embodiment of the present invention;

FIG. 18 is a block diagram of a second example of the structure of the information management system according to the variation of the first embodiment of the present invention; and

FIG. 19 is a block diagram of a third example of the structure of the information management system according to the variation of the first embodiment of the present invention.

### DETAILED DESCRIPTION OF THE PREFERRED EMBODIMENTS

A description will be given below, with reference to the drawings, of embodiments of the present invention.

### First Embodiment

<System Structure>

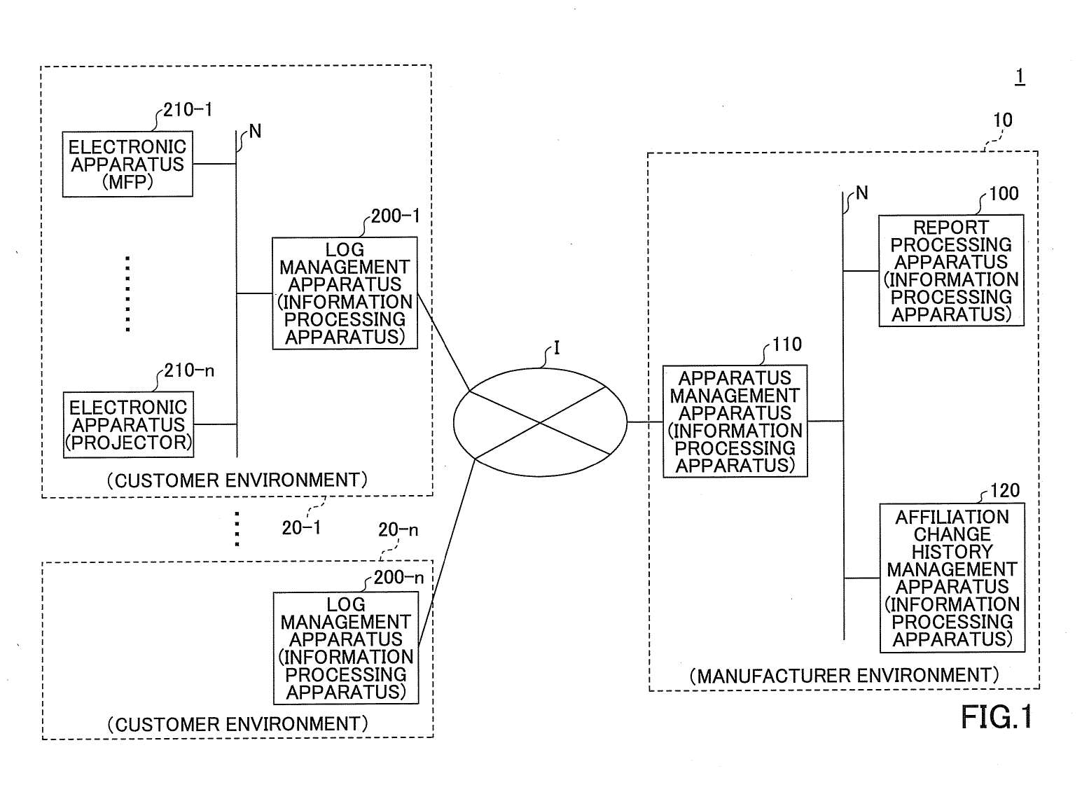

FIG. 1 is a block diagram illustrating a structure of an information management system 1 according to a first embodiment of the present invention.

Illustrated in FIG. 1 is a system structure according to a wide area network in which a plurality of customer environments 20-1˜20-n (hereinafter, may be collectively referred to as “customer environment 20”) are connected to a manufacturer environment 10 through an external network I such as the Internet.

The customer environment 20 is a network environment of a customer side. In the customer environment 20, electronic apparatuses 210-1˜210-n (hereinafter, may be collectively referred to as “electronic apparatus 210”), such as a multifunction peripheral (MFP) and a projector, and log management apparatuses 200-1˜200-n (hereinafter, may be collectively referred to as “log management apparatus 200” are connected through an internal network N such as a local area network (LAN).

The electronic apparatus 210 is an example of an apparatus to be managed (managed apparatus). The log management apparatus 200 has a log management function to manage log information acquired from the electronic apparatus 210. The log management function according to the present embodiment includes acquisition of log information and external notification of acquired information (log sending).

In the manufacturer environment 10 which is a network environment of the manufacturer side, a report processing apparatus 100, an apparatus management apparatus 110 and an affiliation change history management apparatus 120 are mutually connected through the internal network N.

The apparatus management apparatus 110 has an apparatus management function to manage the electronic apparatus 210 based on the acquired information (log information) from the log management apparatus 200 of the customer environment 20. The apparatus management function according to the present embodiment includes recording and retaining of the log information and apparatus status management based on the log information. The affiliation change history management apparatus 120 has an affiliation change history management function, as a function to records a change or transition of an operation environment with respect to contents specified by a contract, to manage the affiliation change history of the electronic apparatus 210. Here, the affiliation change means a change in an area, a country, a site, a group, or a section to which the electronic apparatus 210 belongs or a change of a section or department which owns the electronic apparatus 210. The affiliation change history management function according to the present embodiment includes storage and retaining of the affiliation change history of the electronic apparatus 210 due to a change in an apparatus configuration such as an apparatus installation, an apparatus movement, an apparatus change, and an apparatus removal. The report processing apparatus 100 has a report processing function to perform a report processing with respect to use of the electronic apparatus 210 based on the log information acquired from the apparatus management apparatus 110. The report processing function according to the present embodiment includes aggregation of use status of the electronic apparatus 210 based on the log information and an output of report based on a result of aggregation. Here, aggregation means gathering and summing up the use status information contained in the log information.

The information management system 1 according to the present embodiment realizes the following services.

In the customer environment 20, the log management apparatus 200 acquires log information from the electronic apparatus 210. Consequently, in the log management apparatus 200, the log information is recorded and is retained as management information of log (hereinafter, referred to as “log management information”).

In the manufacturer environment 10, the apparatus management apparatus 110 receives apparatus information from the log management apparatus 200 of each customer environment 20. Consequently, in the apparatus management information 110, apparatus information is recorded and is retained as management information of the electronic apparatus 210 (hereinafter, referred to as “apparatus management information”).

Moreover, in the manufacturer environment 10, the apparatus management apparatus 110 receives information regarding the electronic apparatus 210 (for example, “information regarding a contract or affiliation”) which a management person inputs through a predetermined setting tool. Consequently, the input information is added to the management information and input is added to management information and the management information is retained by the apparatus management apparatus 110.

Moreover, in the manufacturer environment 10, the affiliation change history management apparatus 120 receives information regarding affiliation of the electronic apparatus 210 which the management person input through the predetermined setting tool. Consequently, the input information is recorded in the affiliation change history management apparatus 120, and is retained as management information of affiliation change history (hereinafter, referred to as “affiliation change history management information”).

In this state, in the manufacturer environment 10, upon reception of a report output request, the report processing apparatus 100 accesses the log management apparatus 200, the apparatus management apparatus 110 and the affiliation change history management apparatus 120, and creates and outputs an aggregation report in which the use status of the electronic apparatus 210 is visualized, while referring to the log management information, the apparatus management information and the affiliation change history management information.

As mentioned above, the information management system 1 according to the present embodiment can provide information management service, which can output aggregation report in which an apparatus configuration change is reflected, by integrally managing the electronic apparatus 210 introduced and installed at the customer environment 20.

<Hardware Structure>

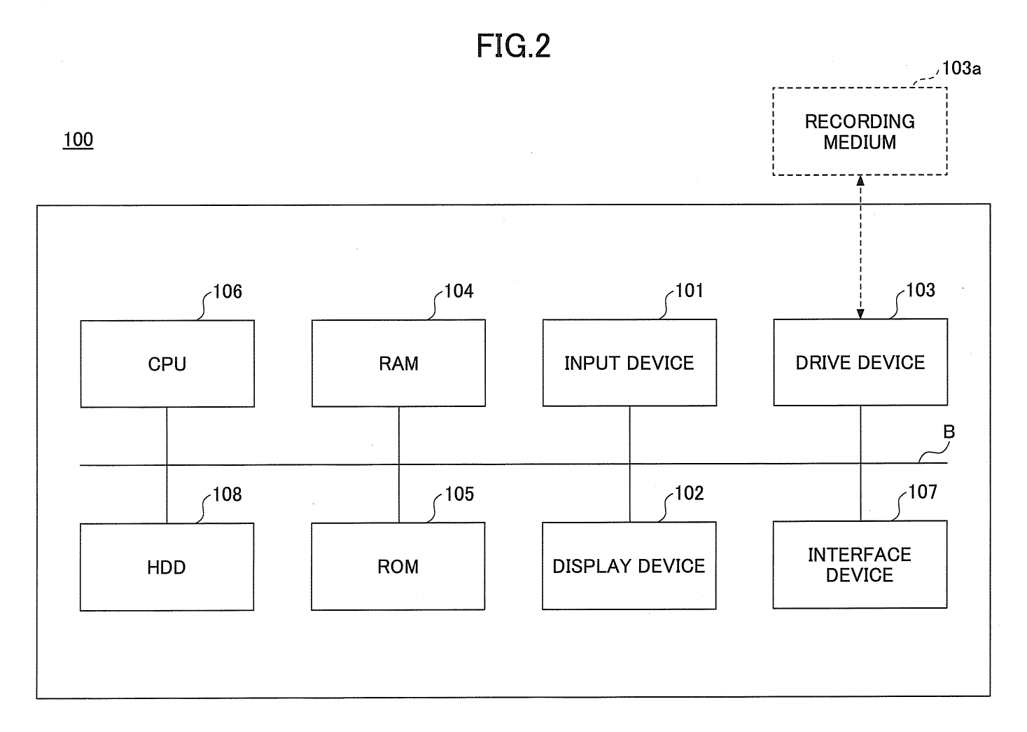

FIG. 2 is a block diagram illustrating a hardware structure of the report processing apparatus 100 (information processing apparatus) according to the present embodiment. Each of the apparatus management apparatus 110, the affiliation change history management apparatus 120 and the log management apparatus 200 that are included in the information management system 1 is an information processing apparatus having the same hardware structure as the report processing apparatus 100 described below.

As illustrated in FIG. 2, the report processing apparatus 100 is equipped with an input device 101, a display device 102, a drive device 103, a random access memory (RAM) 104, a read only memory (ROM) 105 and a central processing unit (CPU) 106, an interface device 107, a hard disk drive (HDD) 108, etc., and those devices are mutually connected through a bus B.

The input device 101 includes a keyboard, a mouth, etc., and is used for inputting an operation signal to the report processing apparatus 100. The display device 102 includes a display unit, etc., and displays a result of processing by the report processing apparatus 100.

The interface device 107 is an interface for connecting the report processing apparatus 100 to a data transmission path (network). The report processing apparatus 100 can perform data communication with other apparatuses having a communication function via the interface device 107.

The HDD 108 is a non-volatility memory device for storing programs and data. The programs and data stored include an information processing system for controlling the entire apparatus (for example, an operating system (OS), which is basic software such as “Windows” (Trademark or Registered Trademark) or “UNIX” (Trademark or Registered Trademark)) and an application providing various kinds of functions on the system. The HDD 108 manages stored programs and data according to a predetermined file system and/or a database (DB).

The drive device 103 is an interface with a detachably attachable recording medium 103a. Thereby, the report processing apparatus 100 can perform reading and/or writing on the recording medium 103a through the drive device 103. The recording medium 103a includes, for example, a floppy disk (Trademark or Registered Trademark), a compact disc (CD), a digital versatile disc (DVD), an SD memory card, a universal serial bus (USB) memory, etc.

The ROM 105 is a non-volatile semiconductor memory (memory device) that can retain internal data even if a power is turned off. The ROM 105 stores a basic input/output system (BIOS), which is executed when the report processing apparatus 100 is activated, and programs and data for setting information processing system and setting a network. The RAM 104 is a volatile semiconductor memory (memory device) for temporarily retaining programs and data. The CPU 106 reads programs and data from the above-mentioned memory device (for example “HDD” and “ROM”) and stores the read programs and data in the RAM 104 in order to perform processing to achieve a control of the entire apparatus and to achieve mounted functions.

As mentioned above, the report processing apparatus 100 according to the present embodiment can provide various information processing services according to the above-mentioned hardware structure.

<Report Processing Function>

A description will be given of a report processing function in the information management service according to the present embodiment.

In the information management system 1 according to the present embodiment, the affiliation change history of the electronic apparatus 210 is recorded based on an affiliation change of the electronic apparatus 210 in the customer environment 20. The information management system 1 crates an aggregation report based on the thus-recorded affiliation change history and the log information acquired from the electronic apparatus 210, and outputs the created aggregation report. The information management system according to the present embodiment has such a report processing function.

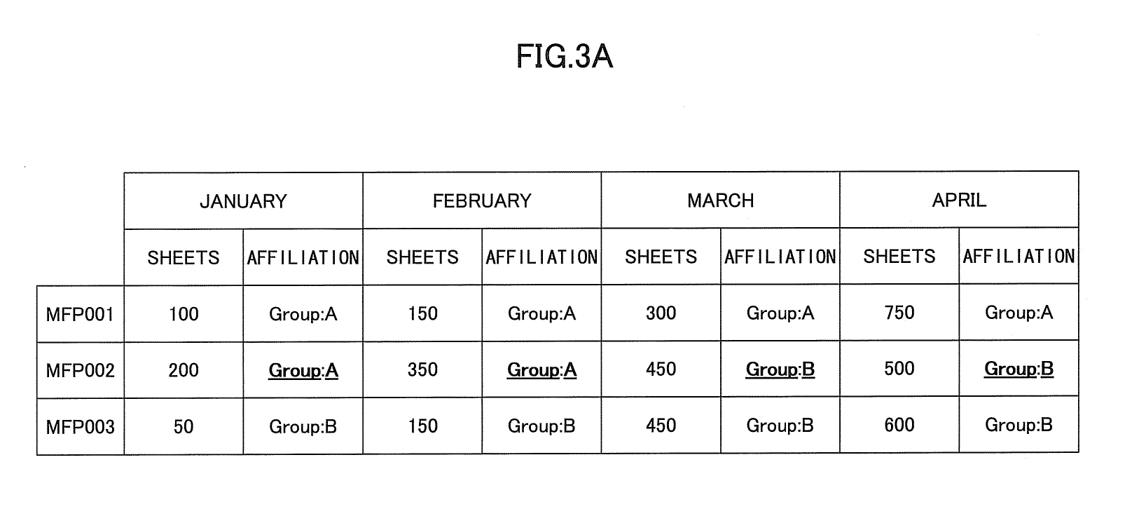

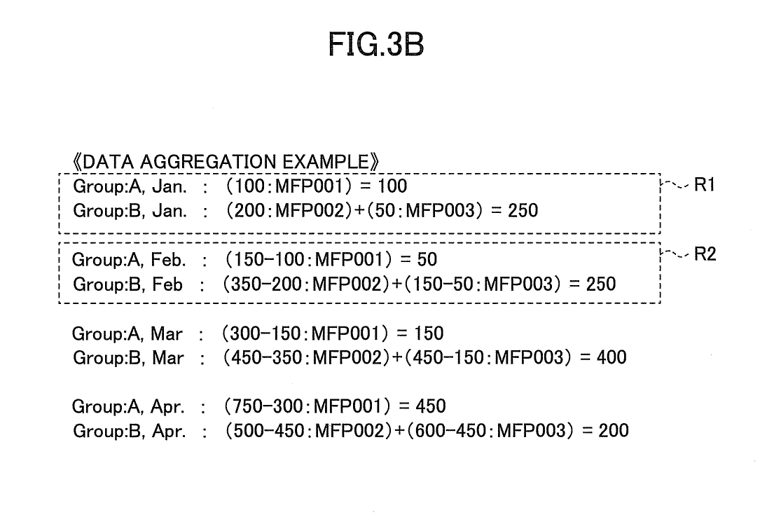

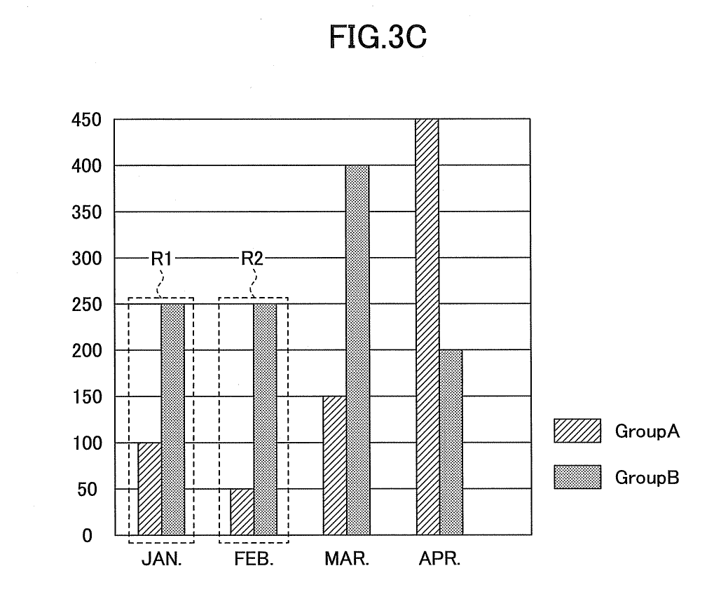

According to a conventional method, when a configuration change of the electronic apparatus 210 is performed in the customer environment 20, an aggregation report such as, for example, illustrated in FIGS. 3A, 3B and 3C is output.

FIGS. 3A, 3B and 3C are illustrations of an example of a conventional report output. FIGS. 3A, 3B and 3C illustrate an example of a report output to a customer for each four-month, the report indicating a result of aggregation of number of output sheets of the electronic apparatus 210 installed in the customer site for each affiliation of the electronic apparatus 210 on a monthly basis.

As illustrated in FIG. 3A, in the customer environment 20, among three MFPs installed at the customer site, an MFP 002 is moved from Group:A to Group:B during a period from February to March, which results in a change in the affiliation of the electronic apparatus 210 (a change in the affiliation of the electronic apparatus 210).

In this case, according to the conventional report output, data aggregation is performed such as illustrated in FIG. 3B based on the output number of sheets of each MFP as illustrated in FIG. 3A, and an aggregation report for four months such as illustrated in FIG. 3C is output.

However, as illustrated in FIG. 3B, according to the data aggregation in the conventional report output, the data aggregation is performed for each affiliation on a monthly basis based on the status after the apparatus is moved in all months (January through April). As a result, an accurate data aggregation can be performed with respect to March and April, which months are after the movement of the apparatus. However, with respect to January and February, which months are before the movement of the apparatus, the data aggregation is performed as if the MFP 002 belongs to Group:B (refer to reference signs R1 and R2 in FIG. 3B), which results in an erroneous aggregation (refer to reference signs R1 and R2 in FIG. 3C).

As mentioned above, the conventional method cannot output an accurate aggregation report in which a change in an apparatus configuration in the customer environment 20.

Such a provision of report output service in the information management is determined in many cases at a time when a contract is made with a customer. In many cases, such a contract may include provisions specifying that the manufacturer must pay a penalty charge to the customer when a criterion of a previously determined service quality is not fulfilled. Thus, a report output based on an erroneous aggregation result may give a loss due to nonfulfillment of the contact to both the customer and the manufacturer. For example, in a case where a certain service quality is not satisfied, there may be in a state where the customer cannot receive a penalty charge. Moreover, there may be a state where the manufacturer must pay a penalty charge even in a case where a certain service quality is satisfied.

Moreover, because the report output service is used in an improvement suggestion of the customer environment 20, a report output based on an erroneous aggregation result may lead to a suggestion of erroneous contents (improper contents).

Thus, the report processing apparatus 100 according to the present embodiment creates and outputs an aggregation report based on the affiliation change history and the log information acquired from the electronic apparatus 210, the affiliation change history indicating a transition of an operation environment of the electronic apparatus 210, which is installed in the customer site, with respect to the contents specified in the contract.

Thereby, the report processing apparatus 100 according to the present embodiment can provide an environment, which can output an aggregation report in which an apparatus configuration change in the customer environment 20 is reflected. As a result, the information management system according to the present embodiment can provide information management service including a high-quality (accurate) report output.

A description will be given below of a structure and an operation of the report processing function in the information management service according to the present embodiment.

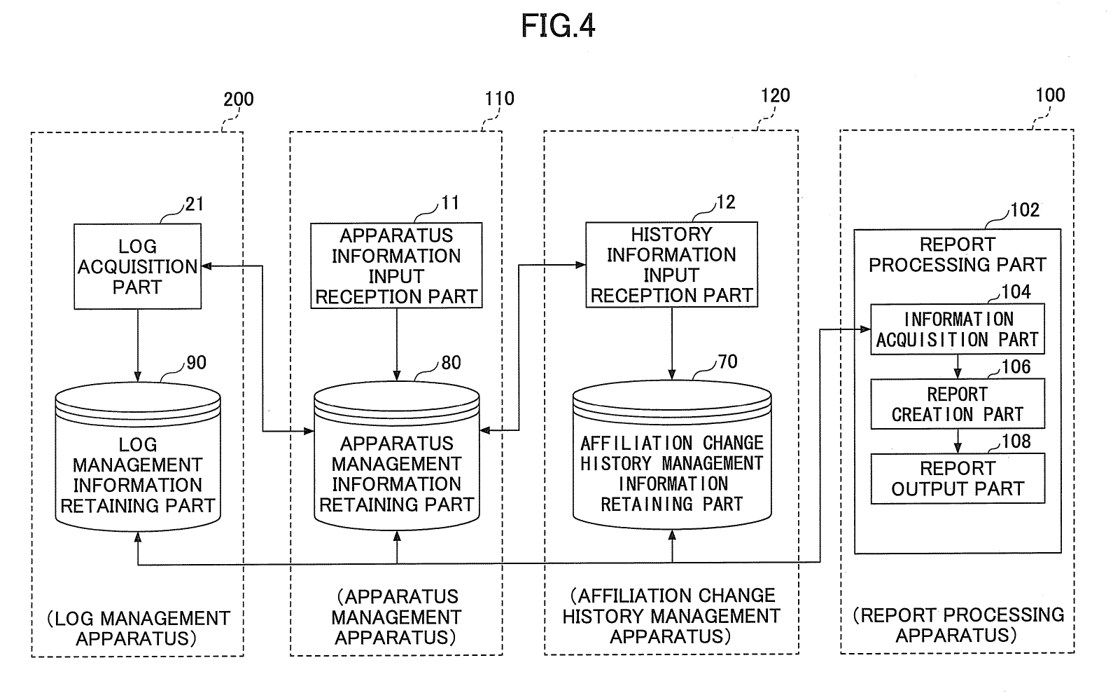

FIG. 4 is a block diagram illustrating a structure of the report processing function according to the present embodiment.

As illustrated in FIG. 4, the report processing function according to the present embodiment is achieved by a collaborative operation of functional parts of the log management apparatus 200, the apparatus management apparatus 110, the affiliation change history management apparatus 120 and the report processing apparatus 100. Each apparatus has the following functional parts.

The log management apparatus 200 includes a log acquisition part 21, etc. The apparatus management apparatus 110 has a apparatus information input reception part 11, etc. The affiliation change history management apparatus 120 has a history information input reception part 12, etc. The report processing apparatus 100 has a report processing part 102, etc.

<<Log Management Apparatus>>

The log acquisition part 21 is a functional part to acquire the log information which indicates use status of the electronic apparatus 210. The log acquisition part 21 searches the electronic apparatus 210 connected to the network of the customer environment 20.

The log acquisition part 21 makes an information acquisition request to the discovered electronic apparatus 210, and acquires log information including use status values such as output number of sheets. In addition, the log acquisition part 21 sends an acquisition request of the log information to the electronic apparatus 210 based on a network setting value (IP address: Internet Protocol address) received as a search result.

Upon acquisition of the log information from the electronic apparatus 210, the log management apparatus 200 stores the acquired log information as log management information in a log management information retaining part 90. The log management information retaining part 90 corresponds to a predetermined memory area of the memory device (HDD) of the log management apparatus 200.

A description is given below of the above-mentioned log management information.

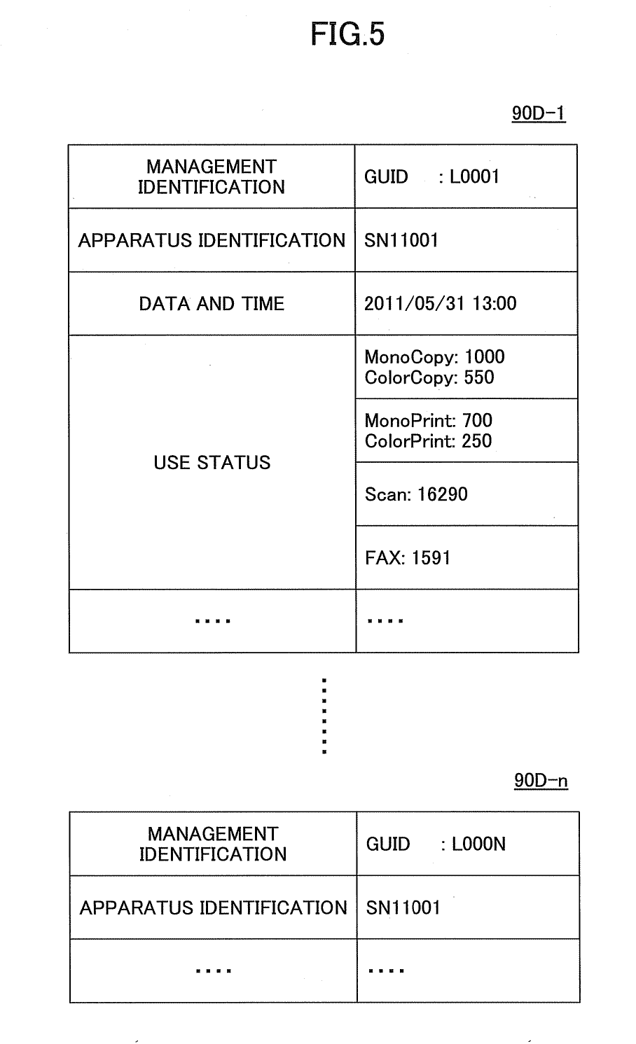

FIG. 5 is an illustration of an example of data of log management information 90D-1˜90D-n according to the present embodiment (hereinafter, may be collectively referred to as “log management information 90D”).

As illustrated in FIG. 5, the log management information 90D is managed as a set of information to which information items such as a management identification, an apparatus identification, date and time, use status, etc., are related for each information acquisition on an individual apparatus basis. Thus, when information is acquired from one unit of the electronic apparatus 210 for a plurality of times, the log management information retaining part 90 retains a plurality of acquired sets of log management information 90D for each apparatus. That is, the use status is recorded for each electronic apparatus 210.

The “management identification” is an item for retaining identification information for managing the log. The item value of the “management identification” item includes management identifier which is uniquely issued at the time of information acquisition. FIG. 5 illustrates data indicating a management identifier such as, for example, an ID numbered in an order of acquisition.

The “apparatus identification” is an item retaining information for identifying the electronic apparatus 210 (hereinafter, referred to as “apparatus identification information”). The item value of the “apparatus identification” includes an apparatus identifier uniquely assigned to the electronic apparatus 210. FIG. 5 illustrates data indicating an apparatus identifier such as, for example, a serial number.

The “date and time” is an item for retaining information indicating information acquisition date and time (information recording date and time) (hereinafter, referred to as “date and time information”). The item value of the “date and time” item includes date and time of acquisition of the log information. FIG. 5 illustrates data indicating acquisition date and time such as, for example, date and time.

Returning to the description of FIG. 4, in the log management apparatus 200, each information item value of the log information acquired from the log management information retaining part 90 is additionally registered as an information item value of the new log management information 90D (added for each information acquisition on an individual apparatus basis).

<<Affiliation Change History Management Apparatus>>

The history information input reception part 12 is a functional part to receive an input of information regarding the affiliation change history of the electronic apparatus 210 (apparatus configuration change history in the customer environment) (hereinafter, simply referred to as “history information”). The history information input reception part 12 receives an input of the history information through a predetermined input screen equipped with GUI (Graphical User Interface). The information input is performed when, for example, a manufacturer's person in charge changes the configuration of the electronic apparatus 210 in the customer environment 20 (at a time of apparatus affiliation change).

Upon reception of the input of the history information by the history information input reception part 12, the affiliation change history management apparatus 120 stores the input history information in the affiliation change history management information retaining part 70 as affiliation change history management information. The affiliation change history management information maintenance part 70 corresponds to the predetermined memory area of the memory device (HDD) included in the affiliation change history management apparatus 120.

A description will now be given of the above-mentioned affiliation change history management information.

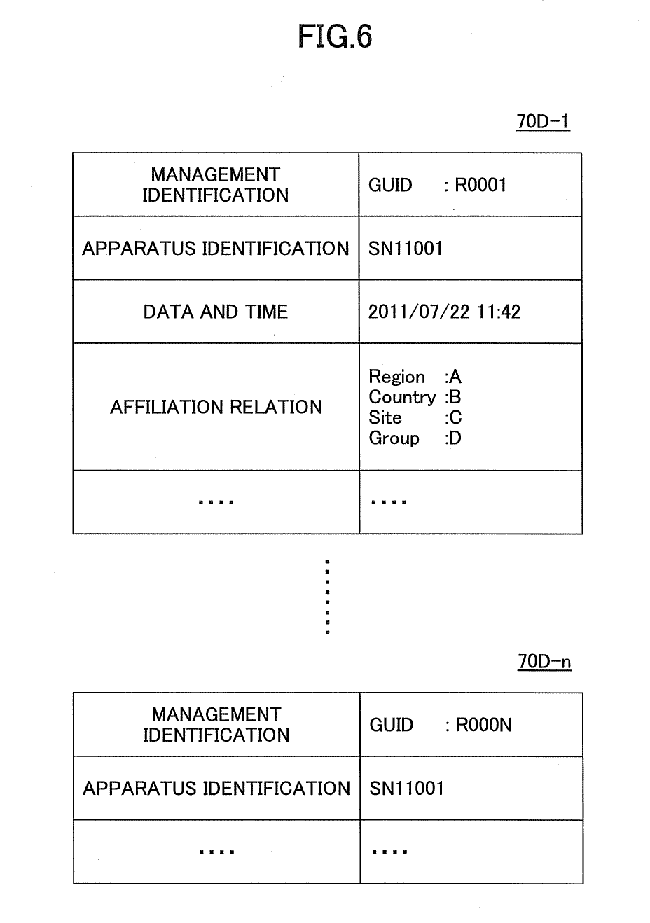

FIG. 6 is an illustration of an example of data of the affiliation change history management information (hereinafter, may be collectively referred to as “affiliation change history management information 70D”).

As illustrated in FIG. 6, the affiliation change history management information 70D is managed as a set of information in which information items such as a management identifier, an apparatus identifier, date and time, an affiliation relation, etc., are related for each information input on an individual apparatus basis. Thus, when the history information input reception part 12 receives an input of the history information over a plurality of times, the affiliation change history management information retaining part 70 retains the input plurality of pieces of history information. That is, the affiliation change history for each electronic apparatus 210 is recorded.

The “management identification” is an item to retain identification information for managing the affiliation change history. The item value of the “management identification” includes a management identifier uniquely issued when receiving the information input. FIG. 6 illustrates data indicating a management such as, for example, an ID numbered in an order of input reception.

The “apparatus identification” is an item to retain apparatus identification information. The item value of the “apparatus identification” includes an apparatus identifier of the electronic apparatus 210 of which affiliation is changed (configuration change target apparatus), the apparatus identifier being contained in the history information. Thus, the affiliation history management information 70D which the affiliation change history management apparatus 120 is linked by the log management information 90D retained by the log management apparatus 200 and the apparatus identification information.

The “date and time” is an item for retaining date and time information. The item value of the “date and time” item includes information input date and time. FIG. 6 illustrates data indicating information input date and time such as, for example, date and time.

The “affiliation relation” is an item to retain information regarding affiliation of the electronic apparatus 210 (hereinafter, referred to as “affiliation relation information”). The item value of the “affiliation relation” item includes an affiliation area (affiliation identifier) of the electronic apparatus 210 in the customer environment 20, the affiliation area being contained in the input information. FIG. 6 illustrates an example of data hierarchically indicating affiliation area such as, for example, a region ‘Region’, a country ‘Country’, a site (large assembly) ‘Site’, a group (small assembly) ‘Group’, etc.

Returning to explanation of FIG. 4, the affiliation change history management apparatus 120 registers each information item value of the input history information in the affiliation change history management information retaining part 70 as an information item value of the new affiliation change history management information 70D (add for each information input on an individual apparatus basis).

<<Apparatus Management Apparatus>>

The apparatus information input reception part 11 is a functional part to receive an input of information regarding the electronic apparatus 210 (hereinafter, simply referred to as “apparatus information”). The apparatus information input reception part 11 receives an input of apparatus information through, for example, a predetermined input screen equipped with GUI. The information input is performed when, for example, a manufacturer's person in charge introduces the electronic apparatus 210 into the customer environment 20.

In the apparatus management apparatus 110, when an input of the apparatus information is received by the apparatus information input reception part 11, the input apparatus information is stored in the apparatus management information retaining part 80 as apparatus management information. The apparatus management information maintenance part 80 corresponds to, for example, a predetermined memory area of the memory device (HDD) included in the apparatus management apparatus 110.

A description is given below of the above-mentioned apparatus management information.

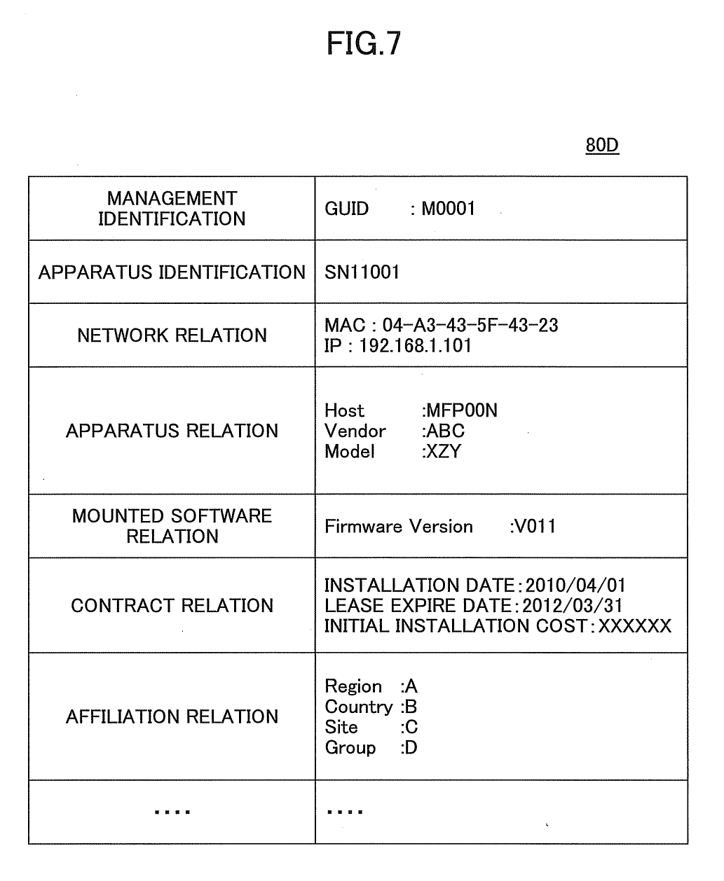

FIG. 7 is an illustration illustrating an example of data of the apparatus management information 80D according to the present embodiment.

As illustrated in FIG. 7, the apparatus management information 80D is managed as a set of information in which a management identification, an apparatus identification, a network relation, an apparatus relation, a mounted software relation, a contract relation, an affiliation relation, etc., on an individual apparatus basis. Thereby, the apparatus management information maintenance part 80 retains the apparatus management information 80D for each apparatus.

Moreover, from among the above-mentioned information items, each information item value such as the apparatus identification, the network relation, the apparatus relation and a mounted software relation, etc., is contained in the apparatus information which the log management apparatus 200 acquires together with log information from the electronic apparatus 210. Thus, upon reception of the apparatus information from the log management apparatus 200 (log acquisition part), the apparatus management apparatus 110 accesses the apparatus management information retaining part 80 to register the information item value of the received apparatus information as each information item value of the apparatus management information 80D. Thereby, those information item values are synchronized between the apparatus management apparatus 110 and the log management apparatus 200.

A “management identification” is an item to retain identification information for managing the electronic apparatus 210. The item value of the “management identification” item contains a management identifier uniquely issued at the time of registering information. FIG. 7 illustrates data indicating a management identifier such as an ID numbered in an order of registration.

An “apparatus identification” is an item to retain apparatus identification information. The item value of the “apparatus identification” item contains an apparatus identifier of the electronic apparatus 210 contained in apparatus information (received information from the log management apparatus). Therefore, the log management apparatus 200 retained by the apparatus management apparatus 110 is linked by the log management information 90D retained by the log management apparatus and the apparatus identification information.

A “network relation” is an item to retain information retarding network setting of the electronic apparatus 210 (hereinafter, referred to as “network relation information”). The item value of the “network relation” item includes a network setting value set to the electronic apparatus 210 which value is included in the apparatus information. FIG. 7 illustrates data indicating a network setting value such as a MAC address (Media Access Control Address), an IP address, etc.

An “apparatus relation” is an item to retain information regarding apparatus setting of the electronic apparatus 210 (hereinafter, referred to as “apparatus relation information”). The item value of the “apparatus relation” item includes an apparatus setting value, which is contained in the log information and set in the electronic apparatus 210 at the time of installing the apparatus. FIG. 7 illustrates data indicating an apparatus setting value such as an apparatus name ‘Host’, a vendor name ‘Vendor’, a model name ‘Model’, etc.

A “loading software relation” is an item to retain information regarding mounted software of the electronic apparatus 210. The item value of the “mounted software relation” item includes information of software installed in the electronic apparatus 210, the software information included in the log information.

An information item value of a contract relation is contained in the apparatus information of which input is received by the apparatus information input reception part 11. Thus, upon reception of an input of the device information by the device information input reception part 11, the apparatus management apparatus 110 registers the information item value based on the input apparatus information.

The “contract relation” is an item to retain information regarding a contract of the electronic apparatus 210 (hereinafter, referred to as “contract relation information”). The item value of the “contract relation” item includes contents of a contract which are included in the apparatus information, the contract being made at the time the electronic apparatus 210 is introduced. FIG. 7 illustrates data indicating contract contents such as apparatus installation date, lease termination date, initial introduction expense, etc.

An affiliation relation information item value is included in the history information of which input is received by the affiliation change history management apparatus 120. Therefore, upon reception of the history information from the affiliate change history management apparatus 120 (history information input reception part), the apparatus management apparatus 110 accesses the apparatus management information retaining part 80 to resister the information item value of the received history information as an “affiliated relation” item value of the apparatus management information 80D. Thereby, the information item value of the affiliate relation is synchronized between the apparatus management apparatus 110 and the affiliate change history apparatus 120.

An “affiliation relation” is an item to retain affiliation relation information. The item value of the “affiliation relation” item includes affiliation area of the electronic apparatus in the customer environment 20, which is contained in the history information (information received from the affiliation change history management apparatus).

Returning to description of FIG. 4, the apparatus management apparatus 110 updates the apparatus management information 80D as follows. Upon reception of an input of the apparatus information by the apparatus information input reception part 11, the apparatus management apparatus 110 accesses the apparatus management information maintenance part 80 to check whether the apparatus management information 80D corresponding to the electronic apparatus 210 of which information input is received has been registered. If it is confirmed that the apparatus management information 80D has been registered, the apparatus management apparatus 110 compares correspondence information values of the apparatus information and the apparatus management information 80D. If the item values are different from each other, the apparatus management apparatus 110 updates the information item value of the apparatus management information 80D using the information item value of the apparatus information.

The update of the apparatus management information 80D can also be performed by the log management apparatus 200 or the affiliation change history management apparatus 120.

For example, the log management apparatus 200 accesses the apparatus management information retaining part 80 to check whether or not the apparatus management information 80D (apparatus management information containing at least one of the “network relation” item, the “apparatus relation” item and the “mounted software relation” item value which is coincident) has been registered. If it is confirmed that the apparatus management information 80D has been registered, the log management apparatus 200 compares the correspondence information item values of the apparatus information and the apparatus management information 80D. If the item values are different from each other, the log management apparatus 200 updates the apparatus management information 80D by sending the apparatus information to the apparatus management apparatus 110. Thereby, the apparatus management apparatus 110 updates the information item value of the apparatus management information 80D by the information item value of the apparatus information received.

The affiliation change history management apparatus 120 accesses the apparatus management information maintenance part 80 to check whether or not the apparatus management information 80D (apparatus management information containing at least the “affiliation relation” item value is coincident) has been registered. If it is confirmed that the apparatus management information 80D has been registered, the affiliation change history management apparatus 120 compares corresponding information item values of the history information and the affiliation relation information of the apparatus management information 80D. If the item values are different form each other, the affiliation change history management apparatus 120 updates the affiliation relation information of the apparatus management information 80D by sending the history information to the apparatus management apparatus 110. Thereby, the apparatus management apparatus 110 updates the “affiliation relation” item value of the apparatus management information 80D by the information item value of the history information received.

<<Report Processing Apparatus>>

The report processing part 102 is a functional part to create and output an aggregation report in which an apparatus configuration change in the customer environment 20 is reflected. Upon reception of a report output request, the report processing part 102 creates the aggregation report by referring to the log management information 90D, the apparatus management information 80D and the affiliation change history management information 70D, and outputs the created aggregation report. Therefore, the report processing part 102 includes functional parts, such as an information acquisition part 104, a report creation part 106, a report output part 108, etc.

The information acquisition part 104 is a functional part to acquire the various kinds of information corresponding to original data for aggregation (the log management information, the apparatus management information and the affiliation change history management information). The information acquisition part 104 acquires the various kinds of information as follows.

The information acquisition part 104 accesses the apparatus management apparatus 110 to acquire the apparatus management information 80D. Thereby, the report processing part 102 displays a designation screen of the electronic apparatus 210 based on the acquired apparatus management information 80D (the “apparatus identification” item value and the “apparatus relation” item value) to receive a designation value (the apparatus identification information) of the apparatus for reporting (report object apparatus). At this time, the report processing part 102 displays the designation screen for each kind of report to receive each designation value for report period for each aggregation unit (report period information and aggregation unit information). The designation value of the aggregation unit includes a designation value of an affiliation area of the report object apparatus (for example, “region/country/side/group”) and a designation value of the aggregation period (for example, “month/year”)

The information acquisition part 104 accesses the log management information retaining part 90 to acquire the log management information 90D (log management information containing the item value concerned) of a designated apparatus during the designated period by referring to the log management information 90D (“apparatus identification” item value and “date and time” item value) based on the received report object device designation (apparatus identification information) and the report period designation (aggregation period information).

The information acquisition part 104 accesses the affiliation change history management information maintenance part 70 to acquire the affiliation change history management information 70D (affiliation change history management information containing the item value concerned) of a designated apparatus during the designated period by referring to the affiliation change history management information 70D (“apparatus identification” item value and “date and time” item value) based on the received report object device designation (apparatus identification information) and the report period designation (aggregation period information).

The report creation part 112 is a functional part to create report data according to a predetermined format based on an aggregation result of each kinds of information acquired. The report creation part 112 aggregates use status based on the log of the report object apparatus in accordance with a report period designation (aggregation period information) received at the time of requesting a report output and an aggregation unit designation (aggregation unit information).

When the report period (4 months) and the aggregation unit (each month) are designated at the time of requesting a report output, the report creation part 112 aggregates the use status in the following manner.

First, the report creation part 112 specifies an affiliation area of the report object apparatus in the designated four months on a monthly basis based on the “apparatus identification” item value, the “date and time” item value and the “affiliation relation” item value by referring to the affiliation change history management information 70D (record of affiliation change history for four months). Here, it is supposed that Group:A and Group:B are specified as the affiliation area of the report object apparatus.

In response, the report creation part 112 aggregates the use status of the report object apparatus, which belongs to Group:A, for four months on a monthly basis and aggregates the use status of the report object apparatus, which belongs to Group:A for four months on a monthly basis based on the “apparatus identification” item value, the “date and time” item value and the “use status” item value by referring to the acquired log management information 90D (record of use status for four months). That is, the report creation part 112 accumulates and aggregates a number of output sheets of the report object apparatus of the same affiliation area for four months on a monthly basis.

An accumulated number of output sheets from the time when the apparatus concerned was installed is recorded in the “use status” item value of the log management information 90. Thus, the report creation part 112 aggregates the use status for each month during the report period by calculating a difference in the number of output sheets on a monthly basis.

As mentioned above, according to the present embodiment, the apparatus use status for each month in which an apparatus configuration change made within the aggregation period in the customer environment 20 can be aggregated.

The report creation part 112 creates report data according to the data format of the report output (for example, “printing/displaying/electronic saving”) according to the request based on the above-mentioned aggregation result.

The report output part 113 is a functional part to output the created report data. The report output part 113 performs the report output according to the request by data transmission, data displaying, or data saving.

As mentioned above, the report processing function in the information management service according to the present embodiment is achieved by the above-mention functional parts performing collaborative operations. It should be noted that each of the above-mentioned functional parts can be achieved by a program (software realizing the information management service including the report processing) installed in each apparatus constituting the system 1 being read from the memory device (“HDD” or “ROM”) and stored in the memory (RAM) by a processing unit (CPU) to perform the following process in each apparatus.

A description will be given of a specific operation (collaborative operation of the group of functional parts) of the report processing function according to the present embodiment. It should be noted that a description is given below sequentially of the management process of each kinds of information (the log management information, the apparatus management information and the affiliation change history management information) and the report output process based on each kinds of information.

<<Information Management Process>>

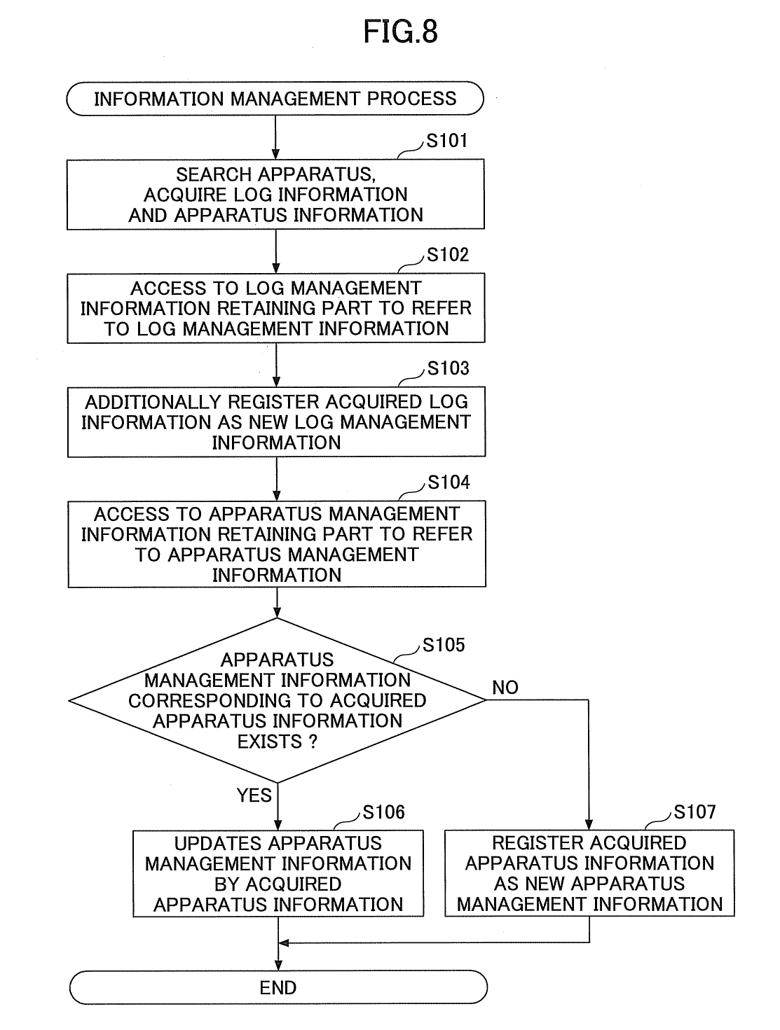

FIG. 8 is a flowchart of a first example of a process procedure of the information management according to the present embodiment. FIG. 8 illustrates an automatic registration process of the log management information 90D, which is performed in the log management apparatus 200, and an automatic registration and updating process of the apparatus management information 80D.

As illustrated in FIG. 8, the log acquisition part 21 of the log management apparatus 200 searches (broadcasts) the electronic device 210 connected to the network of the customer environment 20, and acquires log information from the discovered electronic device 210 (responding apparatus of the broadcast) (step S101). At this time, the log acquisition part 21 also acquires the apparatus information which includes the apparatus identification information, the network relation information, the apparatus relation information, etc. together with the log information.

Then, the log management apparatus 200 accesses the log management information retaining part 90 of its own (step S102), and additionally registers the acquired log information as new log management information 90D (step S103). Thereby, the use status of the electronic device 210 is recorded in the log management apparatus 200.

Then, the log management apparatus 200 accesses the apparatus management information retaining part 80 of the apparatus management apparatus 110 to refer to the apparatus management information 80D (step S104), and determines whether there exists apparatus management information 80D corresponding to the acquired apparatus information by referring to the apparatus management information (step S105). At this time, the log management apparatus 200 determines whether there exists the apparatus management information 80D which includes the “apparatus identification” item value which is coincident on the apparatus identification information of the apparatus information. Thereby, the log management apparatus 200 determines whether the electronic apparatus of which information is acquired is an apparatus which has been registered in the apparatus management apparatus 110.

If the corresponding apparatus management information 80D concerned exists, that is, if it is an already registered apparatus (step S105: YES), the log management apparatus 200 updates the apparatus management information 80D by the acquired apparatus information (step S106). At this time, the log management apparatus 200 requests an update of the apparatus management information 80D by causing the log acquisition part 21 to send the apparatus information to the apparatus management apparatus 110. Consequently, an information updating process is performed in the apparatus management apparatus 110.

On the other hand, if it is determined that the corresponding apparatus management information 80D concerned does not exist, the log management apparatus 200 registers the acquired apparatus information as new apparatus management information 90D (step S107). At this time, the log management apparatus 200 requests a registration of the apparatus management information 80D by causing the log acquisition part 21 to send the apparatus information to the apparatus management apparatus 110. Consequently, an information registration process is performed in the apparatus management apparatus 110.

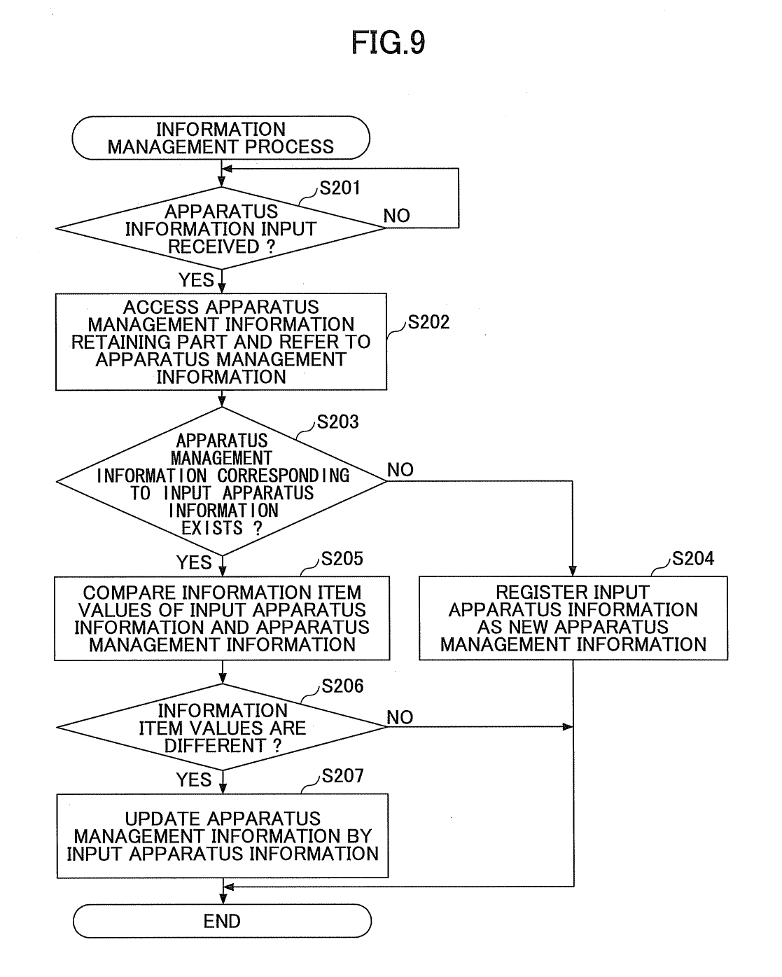

FIG. 9 is a flowchart of a second example of a process procedure of the information management according to the present embodiment. FIG. 9 illustrates a registration and update process of the apparatus management information 80D performed by the apparatus management apparatus 110.

As illustrated in FIG. 9, the apparatus management apparatus 110 receives an input of the apparatus information including the apparatus identification information, the contract relation information, the affiliation relation information, etc., by the apparatus-information input reception part 11 (step S201).

Then, the apparatus management apparatus 110 accesses the apparatus management information retaining part 80 of its own and refers to the apparatus management information 80D (step S202), and determines whether the apparatus management information 80D corresponding to the input apparatus information exists (step S202). At this time, the apparatus management apparatus 110 determines whether apparatus management information 80D including the “apparatus identification” item value which is coincident with the apparatus identification information of the apparatus information exists. Thereby, the apparatus management apparatus 110 determines whether the electronic apparatus 210, which receives the information input, is an already registered apparatus.

If it is determined that the corresponding apparatus management information 80D does not exist, that is, if it is a non-registered apparatus (step S203: NO), the apparatus management apparatus 110 registers the input apparatus information as new apparatus management information 80D (step S204).

On the other hand, if it is determined that the corresponding apparatus management information 80D exists, that is, if it is an already registered apparatus (step S203: YES), the apparatus management apparatus 110 compares the correspondence information item values of the input apparatus information and the corresponding apparatus management information 80D (each item value of the contract relation information and/or the affiliation relation information) (step S205).

Then, the apparatus management apparatus 110 determines whether a result indicating that at least one or more information item value is different is obtained as a result of comparison (step S206). The apparatus management apparatus 110 determines existence or nonexistence of update of the apparatus management information 80D based on the result of comparison.

If a result of comparison indicating that at least one or more information item value is different is obtained b (step S207), the apparatus management apparatus 110 updates the corresponding apparatus management information 80D by the input apparatus information (step S207). At this time, the apparatus management information 110 updates only a different information item value.

In addition, if a result of comparison indicating that all information item values are coincident (step S206: NO), the apparatus management apparatus 110 does not update the apparatus management information 80D.

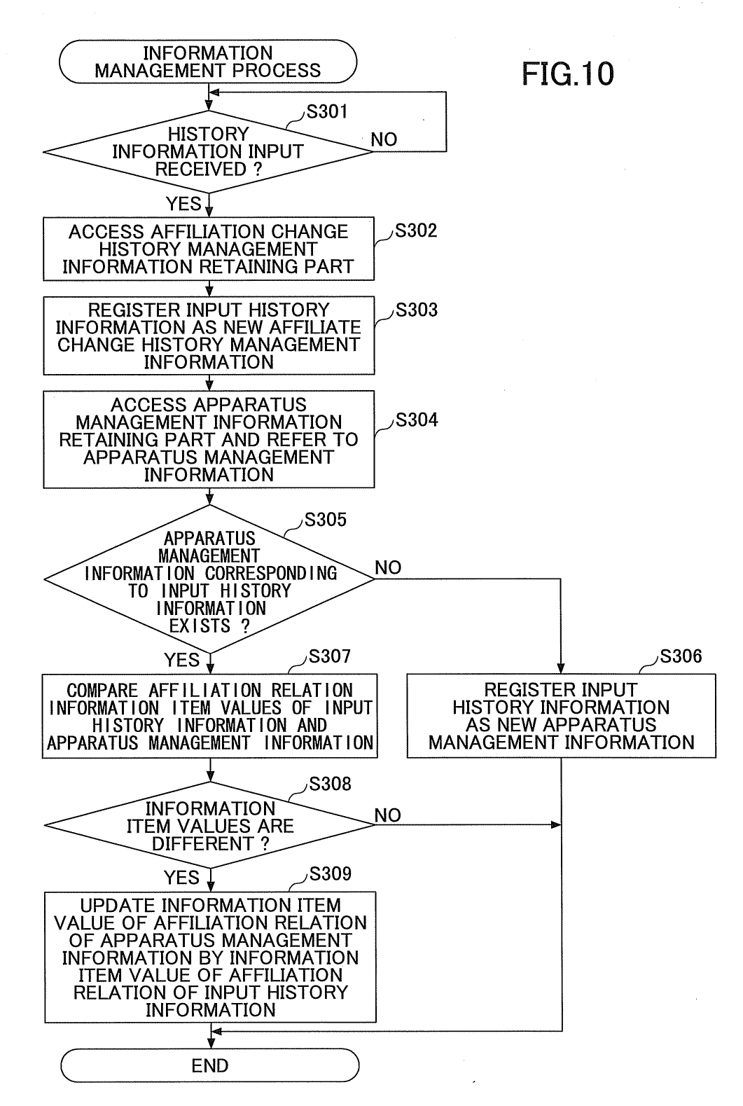

FIG. 10 is a flowchart of a third example of the process procedure of the information management according to the present embodiment. FIG. 10 illustrates a registration process of the affiliation change history management information 70D and an automatic updating process of the apparatus management apparatus 80D that are performed in the affiliation change history management apparatus 120.

As illustrated in FIG. 10, the affiliation change history management apparatus 120 receives an input of the history information including apparatus identification information, the affiliation relation information, etc, by the history information input reception part 12 (step S301). Then, the affiliation change history management apparatus 120 accesses the affiliation change history management information retaining part 70 of its own (step S302), and additionally registers the input history information as new affiliation change history management information 70D (step S303). Thereby, the affiliation change history management apparatus 120 records the affiliation change history of the electronic apparatus 210.

Then, the affiliation change history management apparatus 120 accesses the apparatus management information retaining part 80 of the apparatus management apparatus 110, and refers to the apparatus management information 80D (step S304). Then, the affiliation change history management apparatus 120 determines whether the apparatus management information 80D corresponding to the input history information exists (step S305). At this time, the affiliation change history management apparatus 120 determines whether there exists apparatus management information 80D including the “apparatus identification” item value, which is coincident with the apparatus identification information on the history information. Thereby, the affiliation change history management apparatus 120 determines whether the electronic apparatus 210, which received the information input, is an already registered apparatus.

If it is determined that the corresponding apparatus management information 80D does not exist, that is, if it is a non-registered apparatus (step S305: NO), the affiliation change history management apparatus 120 registers the input history information as new apparatus management information 80D (step S306).

On the other hand, if it is determined that the corresponding apparatus management information 80D exists, that is, if it is an already registered apparatus (step S305: YES), the affiliation change history apparatus 120 compares the “affiliation relation” item values of the input history information and the corresponding apparatus management information 80D (step S307).

Then, the affiliation change history management apparatus 120 determines whether a result indicating that the “affiliation relation” item values are different is obtained as a result of comparison (step S308). Thereby, the apparatus management apparatus 110 determines existence or nonexistence of update of the “affiliation relation” item of the apparatus management information 80D based on the result of comparison.

If a result of comparison indicating that at least one or more information item value is different is obtained (step S207), the apparatus management apparatus 110 updates the corresponding apparatus management information 80D by the input apparatus information (step S207). At this time, the apparatus management information 110 updates only a different information item value.

If a result of comparison indicating that the “affiliation relation” item values are different is obtained (step S308: YES), the affiliation change history management apparatus 120 updates the “affiliation relation” item value of the corresponding apparatus management information 80D by the “affiliation relation” item value of the input history information (step S309). At this time, the affiliation change history management apparatus 120 requests an update of the “affiliation relation” item value of the apparatus management information 80D by causing the history information input reception part 12 to send the history information to the apparatus management apparatus 110. Consequently, the information update process is performed in the apparatus management apparatus 110.

It should be noted that if a result of comparison indicating that the “affiliation relation” item values are the same (step S308: NO), the affiliation change history management apparatus 120 does not update the “affiliation relation” item value of the affiliation change history management information 70D.

<<Report Output Process>>

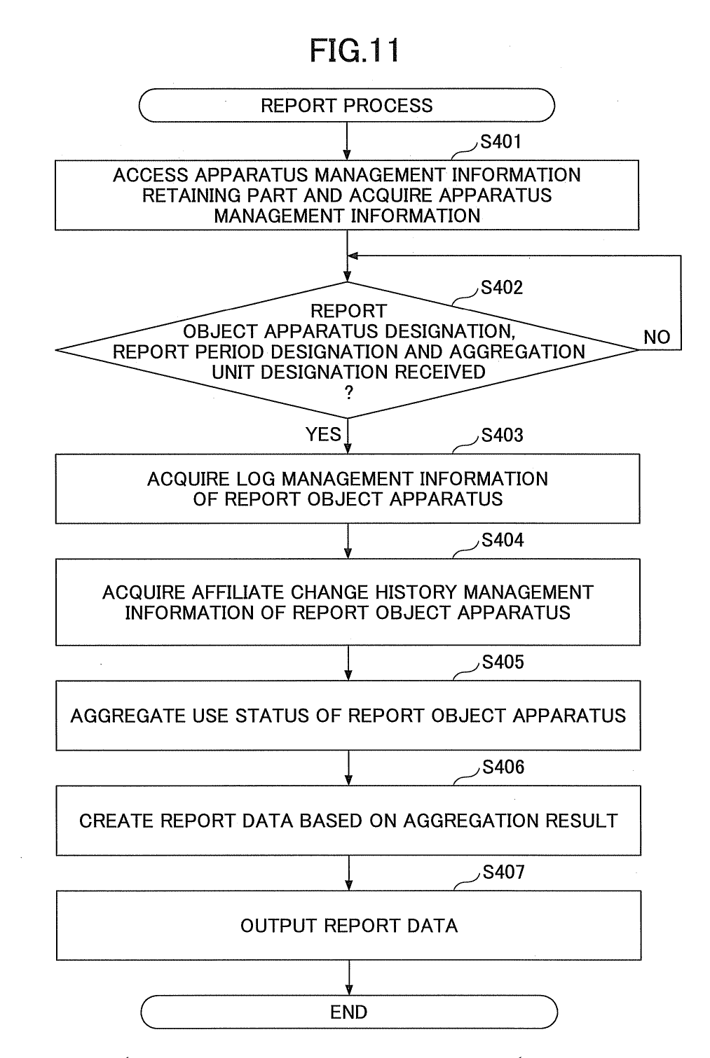

FIG. 11 is a flowchart of an example of a process procedure of the report output according to the present embodiment. FIG. 11 illustrates a process performed by the report process part 102 included in the report process apparatus 100.

As illustrated in FIG. 11, upon reception of a report output request, the report process part 102 accesses the apparatus management information maintenance part 80 of an apparatus management apparatus 110 by the information acquisition part 104 to acquire the registered apparatus management information 80D (step S401). Thereby, a designation screen, which indicates a report object apparatus (a report object apparatus from among the registered apparatuses) and a kind of report including a report period and an aggregation unit, is displayed in the report process apparatus 102.

The report process part 102 determines whether a report object apparatus designation, a report period designation and an aggregation unit designation are received through the designation screen (step S402). After the designation screen is displayed, the report process part 102 is set in a standby state for receiving the above-mentioned designations (step S402: NO), and receives the above-mentioned designations by acquiring the apparatus identification information, which is a designation value of the report object apparatus, the report period information, which is a designation value of the report period, and the aggregation unit information, which is a designation value of the aggregation unit.

If it is determined that the above-mentioned designations are received (information regarding the apparatus identification, the report period and the aggregation unit is acquired) (step S402: YES), the report process part 102 causes the information acquisition part 104 to access the log management information retaining part 90 of the log management apparatus 200, and acquires the log management information 90D of the report object apparatus for the designated report period (step S403). At this time, the information acquisition part 104 specifies the log management information 90D corresponding to the report period based on the report period information by referring to the “date and time” item value of the log management information 90D. Then, the information acquisition part 104 refers to the “apparatus identification” item value of the specified log management information 90D, and specifies the log management information 90D corresponding to the report object apparatus based on the apparatus identification information. Thereby, the report process apparatus 100 acquires log management information 90D of the report object apparatus in the specified report period.

Then, the report process part causes the information acquisition part 104 to access the affiliation change history management information retaining part 70 of the affiliation change history management apparatus 120, and acquires the affiliation change history management information 70D of the report object apparatus in the specified report period (step S404). At this time, the information acquisition part 104 refers to the “date and time” item value of the affiliation change history management information 70D, and specifies the affiliation change history management information 70D corresponding to the report period based on the report period information. Then, the information acquisition part 104 refers to the “apparatus identification” item value of the specified affiliation change history management information 70D, and acquires the affiliation change history management information 70D corresponding to the report object apparatus. Thereby, the report process apparatus 100 acquires the affiliation change history management information 70D of the report object apparatus in the specified report period.

The report process part 102 causes the report creation part 106 to aggregate the use status of the report object apparatus based on the acquired log management information 90D and the acquired affiliation change history management information 70D (step S405). At this time, the report creation part 106 performs the following aggregation process. Here, a description is given of an example where three MFPs (MFP001, MFP002, MFP003) are designated as a report object apparatus, and a month is designated as an aggregation unit (a monthly basis). Moreover, it is assumed that the number of output sheets for each month illustrated in FIG. 3A is recorded in the “use status” item value of the acquired log management information 90D, and the affiliation (apparatus affiliation change history) for each month illustrated in FIG. 3A is recorded in the “affiliation relation” item value of the acquired affiliation change history management information 70D.

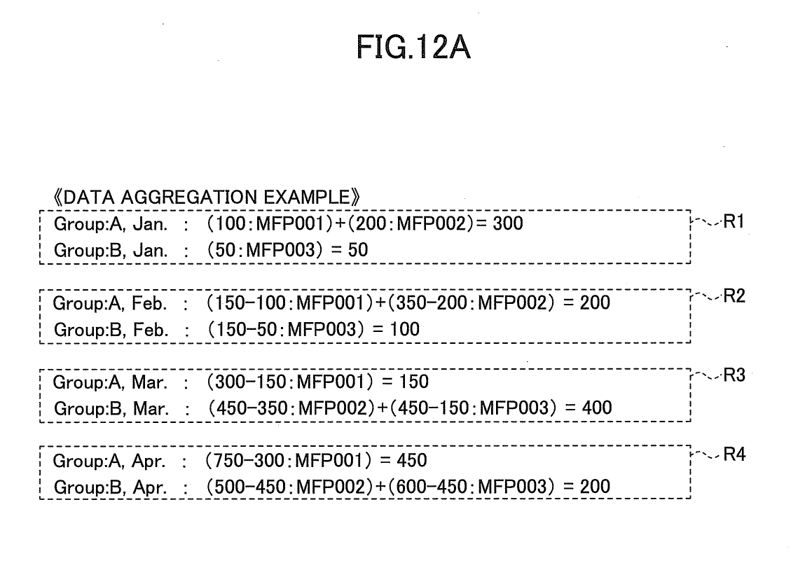

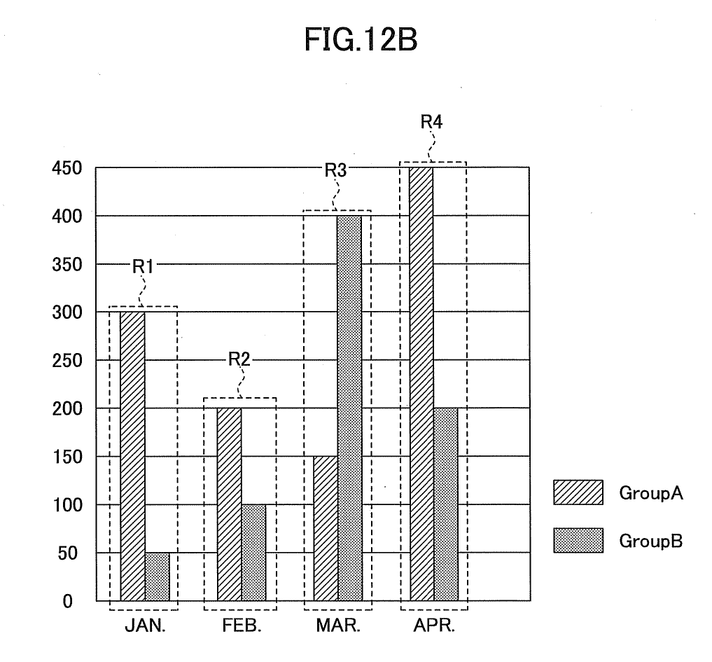

FIGS. 12A and 12B are illustrations of an example of the report output according to the present embodiment. FIG. 12A illustrates an example of a data aggregation in the above-mentioned case. FIG. 12B illustrates a report output based on a result of aggregation.

First, the report creation part 112 specifies an affiliation area of the report object apparatus for four months based on the “apparatus identification” item value, the “date and time” item value, and the “affiliation relation” item value of the acquired affiliation change history management information 70D.

Thereby, the report process apparatus 100 specifies that the MFP001 and MFP002 belonged to Group:A and the MFP003 belonged to Group:B in January and February as indicated by the reference signs R1 and R2 in FIG. 12A. Additionally, the report process apparatus 100 specifies that the MFP001 belonged to Group:A and the MFP002 and the MFP003 belonged to Group:B in March and April as indicated by reference signs R3 and R4 in FIG. 12A.

Thus, in the report creation part 106, the affiliation area of the report object apparatus is specified for each aggregation unit according to the apparatus configuration change between February and March (transfer of the MFP002 from Group:A to Group:B).

Then, the report creation part 106 accumulates and aggregates a number of output sheets of the report object apparatus belonging to Group:A and Group:B for four months based on the “apparatus identification” item value, the “date and time” item value and the “use status” item value of the acquired log management information 90D. Thereby, in the report process apparatus 100, as indicated by the reference sign R1 in FIG. 12A, the value “300” obtained by summing the number of output sheets “100” of the MFP001 belonging to Group:A in January and the number of output sheets “200” of the MFP002 belonging to Group:A in January is calculated as an aggregation value of the report object apparatus belonging to Group:A in January. Additionally, in the report process apparatus 100, the number of output sheets “50” of the MFP003 belonging to Group:B in January is calculated as an aggregation value of the report object apparatus belonging to Group:B in January.

Moreover, in the report process apparatus 100, as indicated by the reference sign R2 in FIG. 12A, the value “200” obtained by summing the number of output sheets “50” of the MFP001 belonging to Group:A in February and the number of output sheets “150” of the MFP002 belonging to Group:A in February is calculated as an aggregation value of the report object apparatus belonging to Group:A in February. Additionally, in the report process apparatus 100, the number of output sheets “100” of the MFP003 belonging to Group:B in February is calculated as an aggregation value of the report object apparatus belonging to Group:B in February.

The accumulated number of output sheets (accumulated value of the use status) from the time when the apparatus concerned is installed in the customer environment 20 is recorded in the “use status” item value of the log management information 90D. Thus, the report creation part 106 aggregates the use status for each month in the report period by calculating a difference between the accumulated number of sheets on a monthly basis. Specifically, as indicated by the reference sign R2 in FIG. 12A, when aggregating the use status of February for the MFP001 and the MFP002 belonging to Group:A, the value “200” is calculated by summing the value “50”, which is obtained by subtracting the accumulated number of output sheets “50” of the MFP001 in January (last month) from the accumulated number of output sheets “150” of the MFP001 in February (this month), and the value “150”, which is obtained by subtracting the accumulated number of output sheets “200” of the MFP002 in January (last month) from the accumulated number of output sheets “350” of the MFP002 in February (this month). Additionally, when aggregating the use status of the MFP003 belonging to Group:B in February, the value “100” is calculated by subtracting the accumulated number of output sheets “50” of the MFP003 in January (last month) from the accumulated number of output sheets “150” of the MFP003 in February (this month).

According to the calculation method mentioned above, in the report process apparatus 100, for example, as indicated by the reference sign R3 of FIG. 12A, the number of output sheets “150=300−150” of the MPF001 belonging to Group:A in March is calculated as an aggregation value of the report object apparatus belonging to Group:A in March. Similarly, in the report process apparatus 100, the value “400” obtained by summing the number of output sheets “100=450−350” of the MPF002 belonging to Group:B in March and the number of output sheets “300=450−150” of the MPF003 belonging to Group:B in March is calculated as an aggregation value of the report object apparatus belonging to Group:B in March.

Moreover, in the report process apparatus 100, for example, as indicated by the reference sign R4 of FIG. 12A, the number of output sheets “450=750−300” of the MPF001 belonging to Group:A in April is calculated as an aggregation value of the report object apparatus belonging to Group:A in April. Similarly, in the report process apparatus 100, the value “200” obtained by summing the number of output sheets “50=500−450” of the MPF002 belonging to Group:B in April and the number of output sheets “150=600−450” of the MPF003 belonging to Group:B in April is calculated as an aggregation value of the report object apparatus belonging to Group:B in April.

As mentioned above, in the report process apparatus 100, apparatus use status is aggregated for each affiliation in which the apparatus configuration change in the customer environment performed in the aggregation period.

Returning to the description of FIG. 11, the report process part 102 creates report data by the report creation part 106 according to the data format of the report output responding to a request (step S406). At this time, the report creation part 106 creates the report data as illustrated in FIG. 12B. FIG. 12B illustrates an example of data in which the result of aggregation of the accumulated number of output sheets of the report object apparatus belonging to Group:A and Group:B for four months from January to April is expressed.

As a result, the report process part 110 causes the report output part 108 to output the created report data.

### CONCLUSION

According to the information management system 1 of the present embodiment, the affiliation change history management apparatus 120 records the affiliation change history of the electronic apparatus 210 based on the apparatus configuration change in the customer environment 20. The report process apparatus 100 of the information management system 1 creates and outputs the aggregation report based on the affiliation change history recorded in the affiliation change history management apparatus 120 and the log information acquired by the log management apparatus 200 from the electronic apparatus 210.

Thereby, the information management system 1 according to the present embodiment can provide an environment capable of outputting an aggregation report in which an apparatus configuration change in the customer environment 20 is reflected. As a result, the information management system 1 according to the present embodiment can provide information management service including outputting a high-quality (accurate) report.

(Variation)

In the above-mentioned embodiment, an affiliation change of the electronic apparatus 210 in the customer environment 20 is recorded by a manufacturer's person in change using the input function of the affiliation change history management apparatus 120. Thus, a variation of the above-mentioned embodiment suggests a system of automatically recording the above-mentioned affiliation change history to reduce a work load of the person in charge. A description is given below of only items different from the above-mentioned embodiment, and the same items are given the same reference numerals and descriptions thereof will be omitted.

<System Structure>

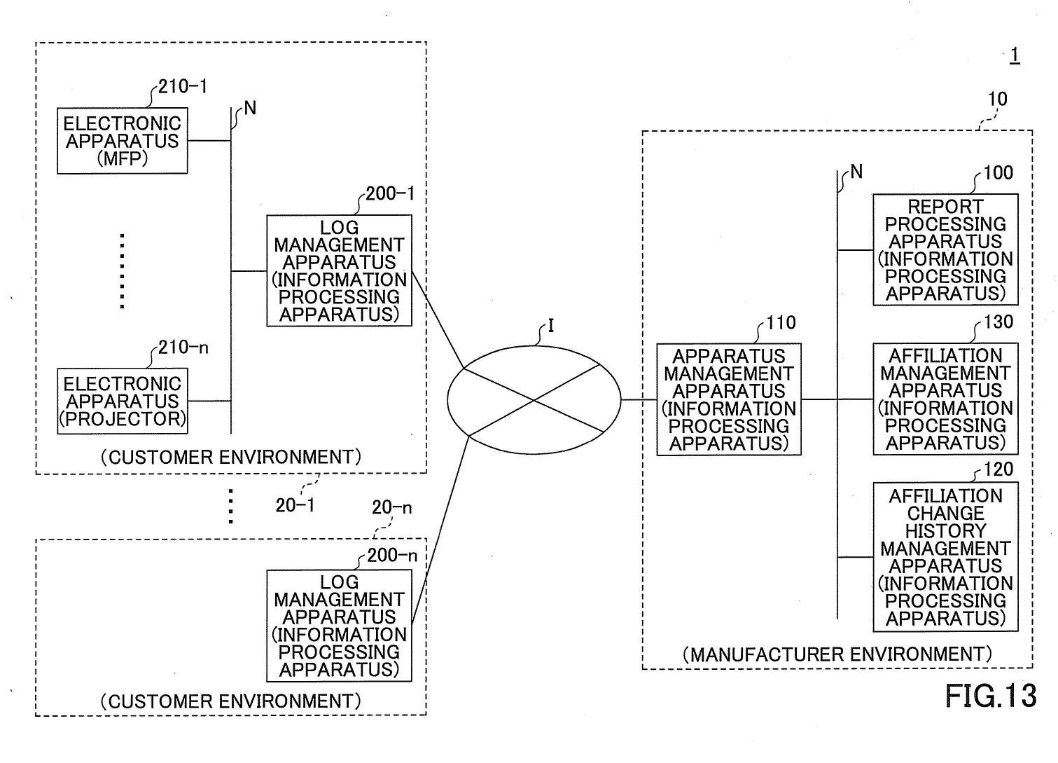

FIG. 13 is a block diagram of a first example of the structure of the information management system 1 according to the present variation.

As illustrated in FIG. 13, in the information management system according to the present variation, the affiliation management apparatus 130 is connected to the internal network N of the manufacturer environment 10. Then, the affiliation change history as a transition of the operation environment with respect to contents specified in a contract is recorded by a collaboration of the affiliation management apparatus 130, the affiliation change history management apparatus 120 and the log management apparatus 200. The affiliation management apparatus 130 has an affiliation management function to manage the affiliation area of the electronic apparatus 210 based on the information acquired from the electronic apparatus 210 installed in each customer environment 20. The affiliation management function according to the present variation includes setting and retaining of management information in which the network setting range and the affiliation area are related (hereinafter, referred to as “affiliation management information”) and determining the affiliation area of the electronic apparatus 210 based on the affiliation management information.

<Report Processing Function>

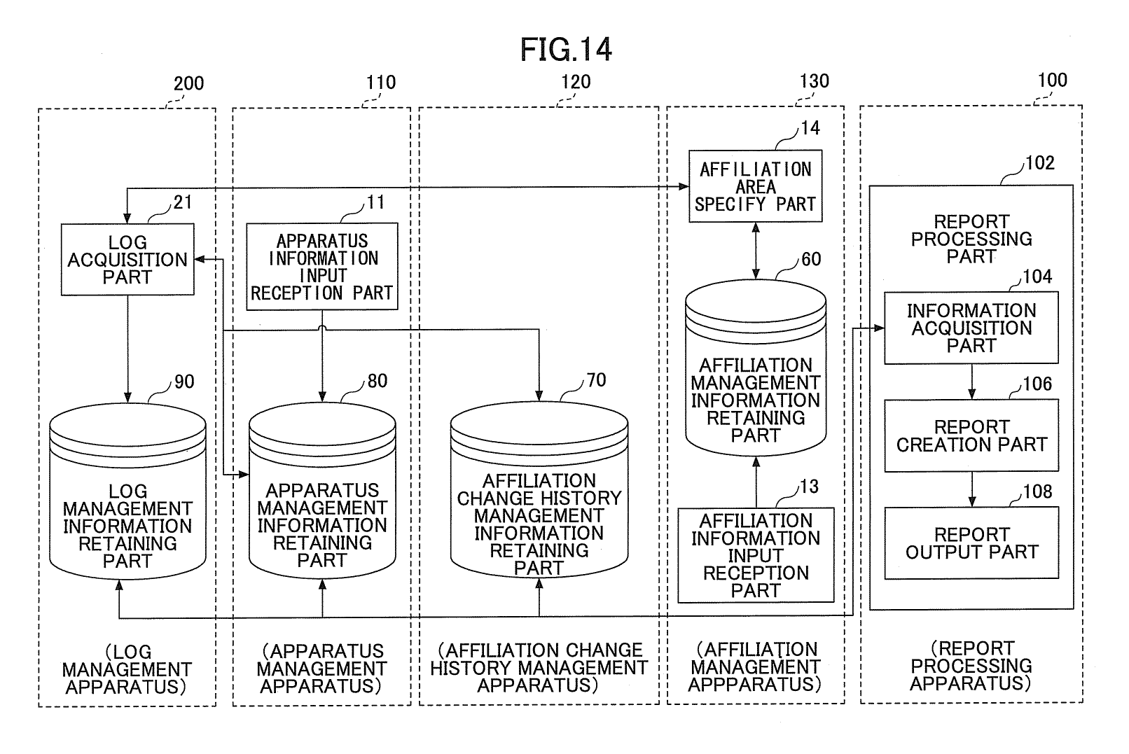

FIG. 14 is a block diagram of a structure of a report processing function according to the present variation.

As illustrated in FIG. 14, the report processing function according to the present variation is achieved by a collaborative operation of functional parts of the log management apparatus 200, the apparatus management apparatus 110, the affiliation change history management apparatus 120, the affiliation management apparatus 130, and the report process apparatus 100. The affiliation management apparatus 130 has a functional part explained below.

The affiliation management apparatus 130 includes an assignment information input reception part 13, an assigned area specify part 14, etc.

The affiliation information input reception part 13 is a functional part to receive an input of information regarding the affiliation area of the electronic device 210 (hereinafter, simply referred to as “affiliation information”). The affiliation information input receptionist part 13 receives an input of affiliation information through a predetermined input screen equipped with GUI. The input of the information is performed by, for example, a manufacturer's person in charge when making a customer contract.

When the assignment information input reception part 13 receives the input of the affiliation information, the affiliation history management apparatus 130 accesses the affiliation management information retaining part 60 to record the input affiliation information, and stores and retains the affiliation information as affiliation management information. The affiliation management information retaining part 60 corresponds to, for example, a predetermined memory area of the memory device (HDD) included in the affiliation management apparatus 130.

A description is given below of the above-mentioned affiliation management information.

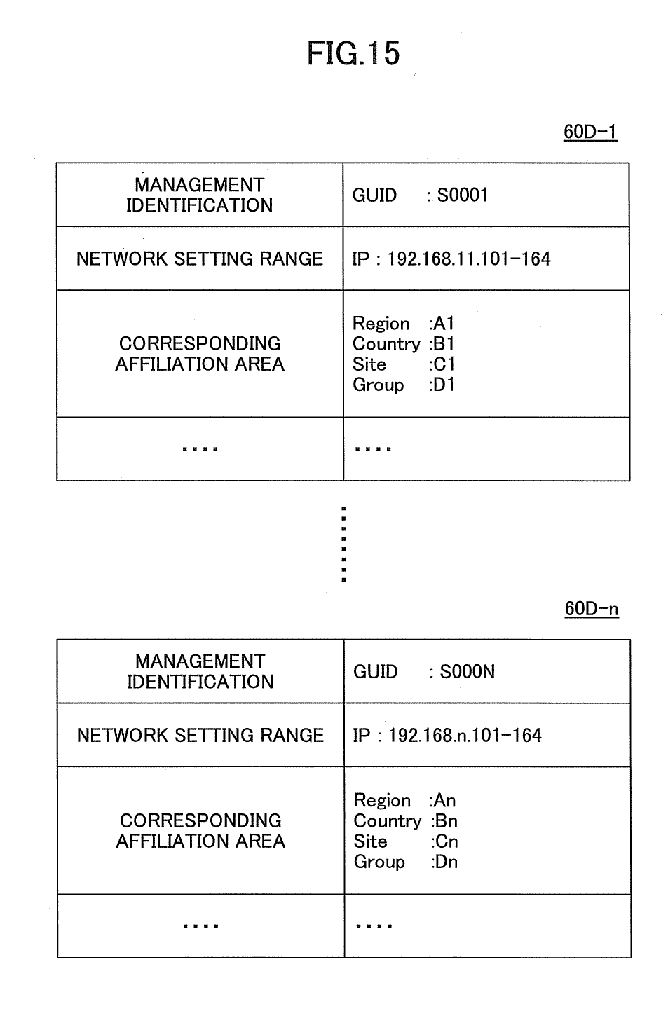

FIG. 15 is an illustration of an example of data of the affiliation management information 60D-1 to 60D-n (hereinafter, may be collectively referred to as “affiliation management information”) according to the present variation.

As illustrated in FIG. 15, the affiliation management information 70D is managed as a set of information in which information items such as the management identification, the network setting range, corresponding affiliation area, etc., are related in an individual network setting unit basis. Thus, the affiliation management information retaining part 60 retains the affiliation management information 60D for each network setting.

The “management identification” item is an item to retain identification information for managing the affiliation area (hereinafter, referred to as “affiliation area management identification information”). The item value of the “management identification” item contains a management identifier uniquely issued at the time of receiving the information input. FIG. 15 illustrates data indicating the management identifier such as an ID numbered in an order of input reception.

The “network setting range” item is an item to retain information regarding the network setting range of the electronic apparatus 210 (hereinafter, referred to as “network setting range information”). The item value of the “network setting range” item contains a range of the network setting value of the electronic apparatus in the customer environment 20. FIG. 15 illustrates data indicating a range of an IP address.

The “correspondence affiliation area” item is an item to retain information regarding the affiliation area of the electronic apparatus 210 corresponding to the above-mentioned network setting range (hereinafter, referred to as “network setting range information”). The item value of the “network setting range” item contains the affiliation area of the electronic apparatus 210 in the customer environment, which is contained in the input information. FIG. 15 illustrates data hierarchically indicating the affiliation area such as region ‘Region’, a country ‘Country’, a site (large assembly) ‘Site’, a group (small assembly) ‘Group’, etc.

Returning to the description of FIG. 14, the affiliation management apparatus 130 accesses the affiliation management information retaining part 60, and additionally registers each information item value of the input affiliation information as an information item value of new affiliation management information 60D (add for each information input on an individual network setting unit basis).

The affiliation area specify part 14 is a functional part to specify an affiliation area of the electronic apparatus 210. The log management apparatus 200 sends the apparatus information, which is received from the electronic apparatus 210 together with the log information, to the apparatus management apparatus 110. As a result, the apparatus management apparatus 110 accesses the apparatus management information retaining part 80, and registers the information item value of the received apparatus information as each information item value of the apparatus management information 80D.

At this time, in the present variation, the log management apparatus 200 sends the apparatus information also to the affiliation management apparatus 130. Upon reception of the apparatus information from the log management apparatus 200, the affiliation management apparatus 130 accesses the affiliation management information retaining part 60. The affiliation area specify part 14 specifies the affiliation area of the electronic apparatus 210 from which the apparatus information is received together with the log information based on the network setting value of the electronic apparatus 210 contained in the received apparatus information by referring to the affiliation management information 60D.

Specifically, the affiliation area specify part 14 specifies the affiliation management information 60D including the “network setting range” item to which the network setting value of the electronic apparatus 210 contained in the apparatus information corresponds, and acquires the “correspondence affiliation area” item value of the specified affiliation management information 60D. The affiliation area specify part 14 specifies the affiliation area of the electronic device 210 from the acquired “correspondence affiliation area” item value.

The affiliation area specify part 14 sends the thus-acquired correspondence affiliation area information to the log management apparatus 200 (the log acquisition part) which is a sender of the apparatus information.

Consequently, the log management apparatus 200 registers and updates the affiliation relation information of the apparatus management information 80D by the acquired correspondence affiliation area information, as explained below.

For example, the log management apparatus 200 accesses the apparatus management information retaining 80, and checks whether the apparatus management information 80D corresponding to the acquired apparatus information (apparatus management information of which apparatus identification information is coincident) has been registered. If the apparatus management information 80D does not exist, the log management apparatus 200 registers the affiliation relation information of the apparatus management information 80D by sending the acquired correspondence affiliation area information to the apparatus management apparatus 110. Thereby, the apparatus management apparatus 110 registers the “affiliation relation” item value of the received apparatus management information 80D by the information item value of the received correspondence affiliation area information.

On the other hand, if the apparatus management information 80D is found, the log management apparatus 200 compares the correspondence information item values of the acquired correspondence affiliation area information and the affiliation relation information of the corresponding apparatus management information 80D. If the item values are different from each other, the log management apparatus 200 updates the affiliation relation information of the apparatus management information 80D by sending the correspondence affiliation area information to the apparatus management apparatus 110. Thereby, the apparatus management apparatus 110 updates the “affiliation relation” item value of the apparatus management information 80D by the information item value of the received correspondence affiliation area information.

Moreover, if a comparison result indicating that the correspondence information item values of the correspondence affiliation area information and the affiliation relation information of the corresponding apparatus management information 80D are different from each other, the log management apparatus 200 registers the affiliation relation information of the affiliation change history management information 70D by the correspondence affiliation area information as explained below.

The log management apparatus 200 registers the affiliation relation information of the affiliation change history management information 70D by sending the acquired correspondence affiliation area information to the affiliation change history management apparatus 120. Thereby, the affiliation change history management apparatus 120 registers the “affiliation relation” item value of the affiliation change history management information 70D by the information item value of the received correspondence affiliation area information.

Thus, in the present variation, if the affiliation area of the electronic apparatus 210 specified by the affiliation management apparatus 130 differs from the affiliation area registered as the apparatus management 80D in the apparatus management apparatus 110, it is regarded that an affiliation change (apparatus configuration change) of the electronic apparatus 210 has been performed in the customer environment 20, and the registration information (affiliation relation information) of the apparatus management apparatus 110 and the affiliation change history management apparatus 120 is updated.

As mentioned above, the report processing function in the information management service according to the present variation is achieved by the above-mentioned functional parts performing a collaborative operation.

A description is given, with reference to a flowchart indicating a process procedure, of an operation (a collaborative operation of a group of functional parts) of the report processing function according to the present variation. A description is given below of a management process of the above-mentioned each kind of information (the affiliation management information, the apparatus management information and the affiliation change history management information).

<<Information Management Process>>

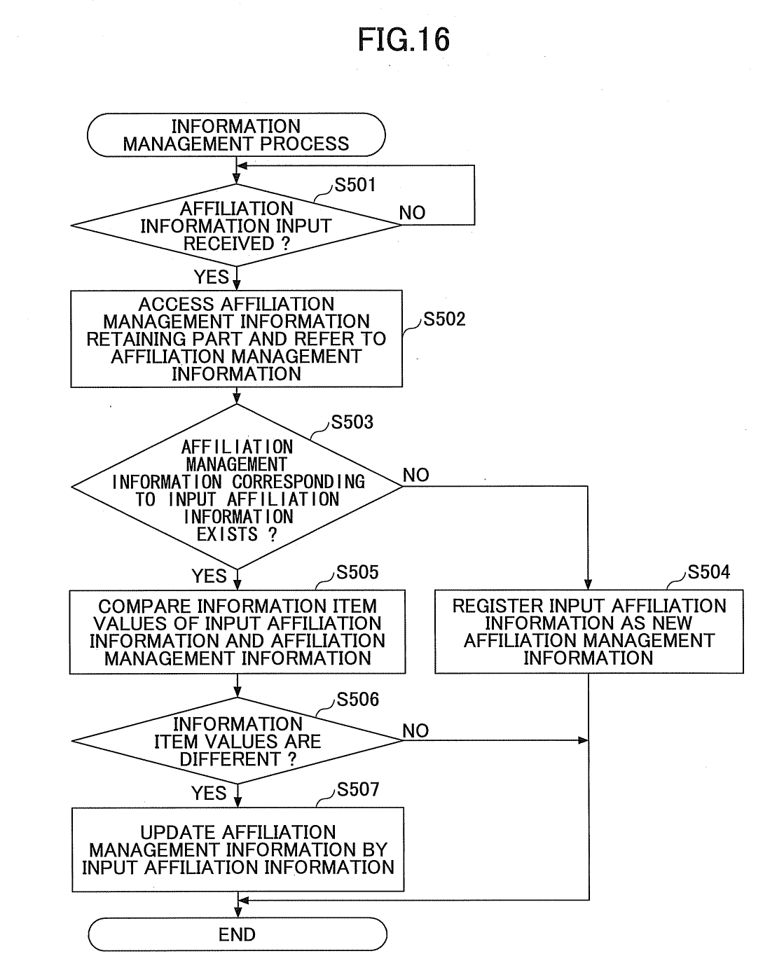

FIG. 16 is a flowchart of a first example of a process procedure of the information management according to the present variation. FIG. 16 illustrates a registration and updating process of the affiliation management information 60D performed in the affiliation management apparatus 130.

As illustrated in FIG. 16, the affiliation information input reception part 13 of the affiliation management apparatus 130 receives an input of the affiliation information containing network-setting-range information, corresponding affiliation area information, etc. (step S501).

Subsequently, the affiliation management apparatus 130 accesses the affiliation management information retaining part 60 of its own, and refers to the affiliation management information 60D (step S502). Then, the affiliation management apparatus 130 determines whether the affiliation management information 60D corresponding to the input affiliation information exists (step S503). At this time, the affiliation-management apparatus 130 determines whether affiliation management information 60D including the “network-setting-range” item value which is coincident with the network-setting range information of the affiliation information exists. Thereby, the affiliation management apparatus 130 determines whether the network setting range of which information input is received is an already registered setting range.

If it is determined that the corresponding affiliation management information 60D does not exist, that is, if it is a non-registered setting range (step S503: NO), the affiliation management apparatus 130 registers the input affiliation information as new affiliation management information 60D (step S504). On the other hand, if it is determined that the corresponding affiliation management information 60D exists, that is, if it is an already registered setting range (step S503: YES), the affiliation management apparatus 130 compares the “corresponding affiliation area” item values of the input affiliation information and the corresponding affiliation management information 60D (step S505).

Then, the affiliation-management apparatus 130 determines whether the result of comparison indicates that the “corresponding affiliation area” item values differ from each other (step S506). Thereby, the affiliation-management apparatus 130 determines existence or nonexistence of an update of the “corresponding affiliation area” item of the affiliation management information 60D based on the result of comparison.

If a result of comparison indicates that the “corresponding affiliation-area” item values are different from each other (step S506: YES), the affiliation management apparatus 130 updates the “corresponding affiliation area” item value of the corresponding affiliation management information 60D by the “corresponding affiliation area” item value of the input affiliation information (step S507).

On the other hand, if a result of comparison indicates that the “corresponding affiliation area” item values are the same (step S506: NO), the affiliation management apparatus 130 does not update the affiliation management information 60D.

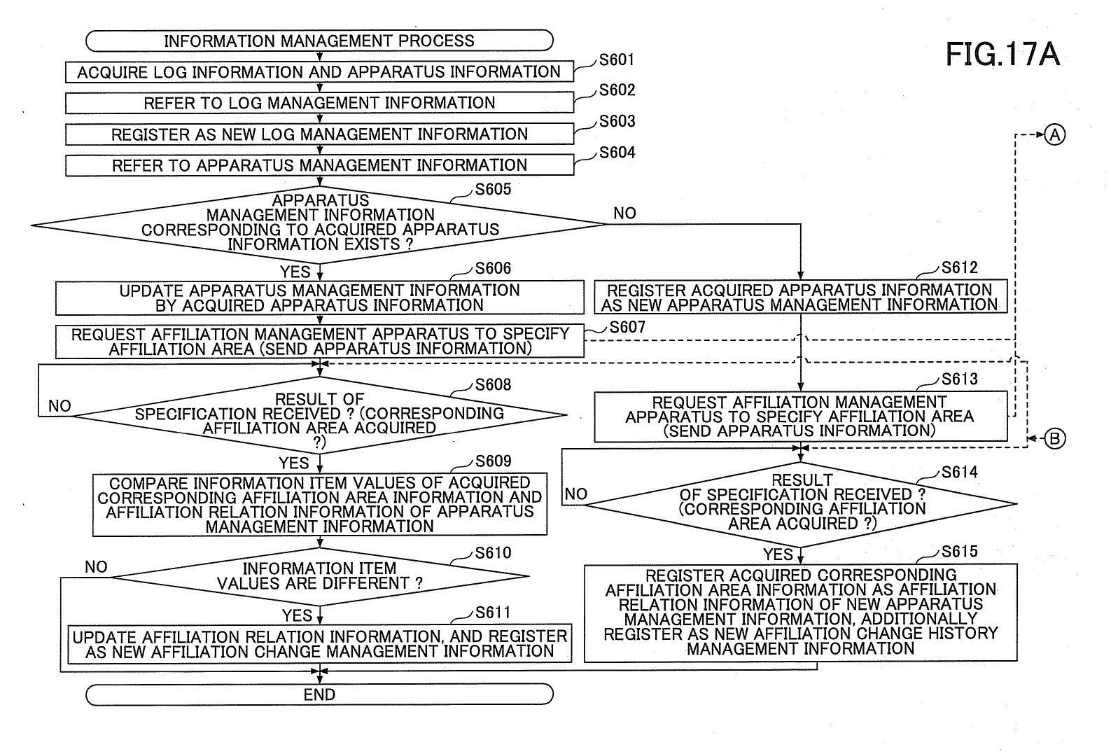

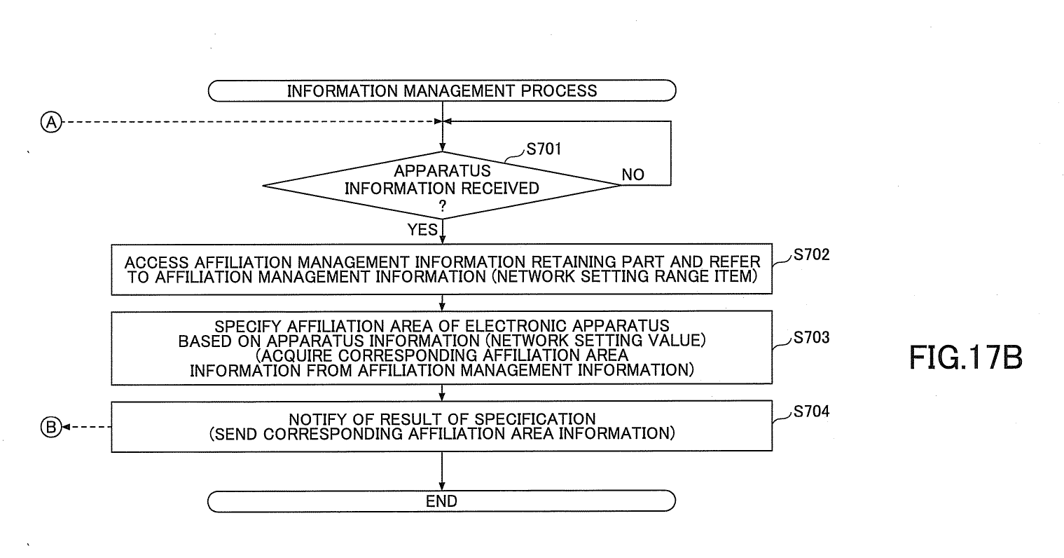

FIGS. 17A and 17B are flowcharts of a second example of the process procedure of the information management according to the present variation. FIG. 17A illustrates an automatic registration process of the log management information 90D, an automatic registration and updating process of the apparatus management-information 80D, and an automatic registration and updating process of the affiliation change history management information 70D, which are performed by the log management apparatus 200. FIG. 17B illustrates an affiliation area specifying process performed by the affiliation management apparatus 130.

Steps S501-S604 illustrated in FIG. 17A are the same as the steps S101-S104 illustrated in FIG. 8, and descriptions thereof will be omitted. Thus, a description will be given of a process after step S605.

As illustrated in FIG. 17A, the log management apparatus 200 accesses the apparatus management information retaining part 80 of the apparatus management apparatus 110, and refers to the apparatus management information 80D (step S604). Then, the log management apparatus 200 determines whether the apparatus management information 80D corresponding to the acquired device information exists (step S605). At this time, the log management apparatus 200 determines whether the apparatus management information 80D including “apparatus identification” item value which is coincident with the apparatus identification information of the device information exists. Thereby, the log management apparatus 200 determines whether the electronic apparatus 210 of which information is acquired has already been registered in the apparatus management apparatus 110.

Consequently, if it is determined that the corresponding apparatus management information 80D exists (step S605: YES), the log management apparatus 200 updates the corresponding apparatus management information 80D by the acquired apparatus information (step S606). At this time, the log management apparatus 200 requests updating of the apparatus management information 80D by causing the log acquisition part 21 to send the apparatus information to the apparatus management apparatus 110. As a result, the information update process is performed in the apparatus management apparatus 110.

Then, the log management apparatus 200 requests specifying an affiliation area of the electronic apparatus from which the log information and the apparatus information are acquired (step S607). At this time, the log management apparatus 200 causes the log acquisition part 21 to send the acquired apparatus information to the affiliation management apparatus 130.

Consequently, the log management apparatus 200 is set in a standby state to wait for a notification of a result of specification of an affiliation area (step S609).

As illustrated in FIG. 17B, when the affiliation management apparatus 130 receives the apparatus information from the log management apparatus 200 (step S701: YES), the affiliation area specify part 14 performs the following specifying process.

The affiliation area specify part 14 accesses the affiliation management information retaining part 60 of its own, and refers to the “network setting range” item of the affiliation management information 60D (step S702).

Then, the affiliation area specify part 14 specifies the affiliation area of the electronic apparatus 210 (an area to which the electronic apparatus belongs) based on the received apparatus information (step S703). At this time, the affiliation area specify part 14 specifies the affiliation management information 60D including the “network setting range” item to which the network setting value of the electronic apparatus 210 contained in the apparatus information corresponds, and acquires the “corresponding affiliation area” item value of the specified affiliation management information 60D.

Consequently, the affiliation area specify part 14 notifies the log management apparatus 200 of a result of specification (step S704). At this time, the affiliation area specify part 14 sends the acquired “corresponding affiliation area” item value (corresponding affiliation area information) to the log management apparatus 200 as the result of specification.

Returning to the description of FIG. 17A, when the log acquisition part 21 of the log management apparatus 200 receives the notification of the result of specification of the affiliation area from the affiliation management apparatus 130 (step S608: YES), the log management apparatus 200 compares the acquired corresponding affiliation area information and the “affiliation relation” item value of the corresponding apparatus management information 80D of step S606 (step 609).

Then, the log management apparatus 200 determines whether a result indicating the “correspondence relation” item values are different from each other is obtained (step S610). Thereby, the log management apparatus 200 determines existence or nonexistence of an update of the “affiliation relation” item of the apparatus management information 80D based on the result of comparison.

If a result of comparison indicating that the “affiliation relation” item values are different is obtained (step S610: YES), the log management apparatus 200 updates the “affiliation relation” item value of the corresponding apparatus management information 80D by the acquired corresponding affiliation area information (step S610: YES). Moreover, the log management apparatus 200 accesses the affiliation change history management information retaining part 70, and additionally registers acquired correspondence affiliation area information as new affiliation change history management information 70D (step S611). At this time, the log management apparatus 200 requests updating of the “affiliation relation” item value of the apparatus management information 80D by causing the log acquisition part 21 to send the correspondence affiliation area information to the apparatus management apparatus 110. Consequently, the information updating process is performed in the apparatus management apparatus 110. Moreover, the log management apparatus 200 requests a new registration of the “affiliation relation” item value of the affiliation change history management information 70D by causing the log acquisition part 21 to send the correspondence affiliation area information to the affiliation change history management apparatus 120. As a result, the information updating process is performed in the affiliation change history management apparatus 120. Thereby, the affiliation change history of the electronic apparatus 210 is recorded automatically in the affiliation change history management apparatus 120.

It should be noted that if a result of comparison indicating that the “affiliation relation” item values are the same is obtained (step S610: NO), the log management apparatus 200 does not update the apparatus management information 80D.

On the other hand, if it is determined that the corresponding apparatus management information 80D does not exist, that is, if it is a non-registered apparatus (step S605: NO), the log management apparatus 200 registers the acquired device information as new apparatus management information 90D. Moreover, the log management apparatus 200 accesses the affiliation change-history management information retaining part 70, and additionally registers the acquired corresponding affiliation area information as new affiliation change history management information 70D (step S612). At this time, the log management apparatus 200 requests a registration of the apparatus management information 80D by causing the log acquisition part 21 to send the apparatus information to the apparatus management apparatus 110. As a result, the information registration process is performed in the apparatus management apparatus 110.

Then, the log management apparatus 200 requests specifying of the affiliation area of the electronic apparatus 210 from which the log information and the apparatus information are acquired (step S613). At this time, the log acquisition part 21 of the log management apparatus 200 sends the acquired device information to the affiliation management apparatus 130.

Consequently, the log management apparatus 200 is set in a standby state to wait for a reception of a result of specification of the affiliation area (step S614: NO).

When the log acquisition part 21 of the log management apparatus receives a notification of a result of specification of the affiliation area from the affiliation management apparatus 130 (step S614: YES), the log management apparatus 200 registers the acquired correspondence affiliation area information as the “affiliation relation” item value of new apparatus management information 80D. Moreover, the log management apparatus 200 accesses the affiliation change history management information retaining part 70, and additionally registers the acquired correspondence affiliation area information as new affiliation change history management information 70D (step S615). At this time, the log management apparatus 200 requests a new registration of the “affiliation relation” item value of the apparatus management information 80D by causing the log acquisition part to send the correspondence area information to the apparatus management apparatus 110. As a result, the information registration process is performed in the apparatus management apparatus 110. Moreover, the log management apparatus 200 requests a new registration of the “affiliation relation” item value of the affiliation change history management information 70D by causing the log acquisition part 21 to send the correspondence affiliation area information to the affiliation change history management information 70D. As a result, the information registration process is performed in the affiliation change history management apparatus 120. Thereby, the affiliation change history is automatically recorded in the affiliation change history management apparatus 120.

### SUMMARY

As mentioned above, according to the information management system 1 of the present embodiment, the affiliation management apparatus 130 specifies the changed affiliation area of the electronic apparatus 210 of which affiliation is changed in the customer environment 20, and the log management apparatus 200 records the affiliation change history of the electronic apparatus 210 in the affiliation change history management apparatus 120 based on the specified affiliation area. The report process apparatus 100 of the information management system 1 creates the aggregation report based on the affiliation change history recorded in the affiliation change history management apparatus 120 and the log information acquired by the log management apparatus 200 from the electronic apparatus 210, and outputs the created aggregation report.

Accordingly, the information management system 1 according to the present variation can provide the same effect as the first embodiment mentioned above. Additionally, in the information management system 1 according to the present variation, the affiliation change history of the electronic apparatus 210 is automatically recorded, thereby reducing a work burden of a person in charge who has performed information input.

The “report processing function” according to the above-mentioned embodiment and the variation thereof is achieved by a processing unit (CPU) of the report process apparatus 100 executing a program which describes each process procedure explained above with reference to the figures in a programming language applicable to the operating environment (platform).

Such a program can be stored in a computer readable recording medium 103a. Thus, the program can be installed to the report process apparatus 100 through the drive device 103. Moreover, because the report process apparatus 100 is equipped with the interface device 107, such a program can be downloaded through an electric communication line, and can be installed in the report process apparatus.

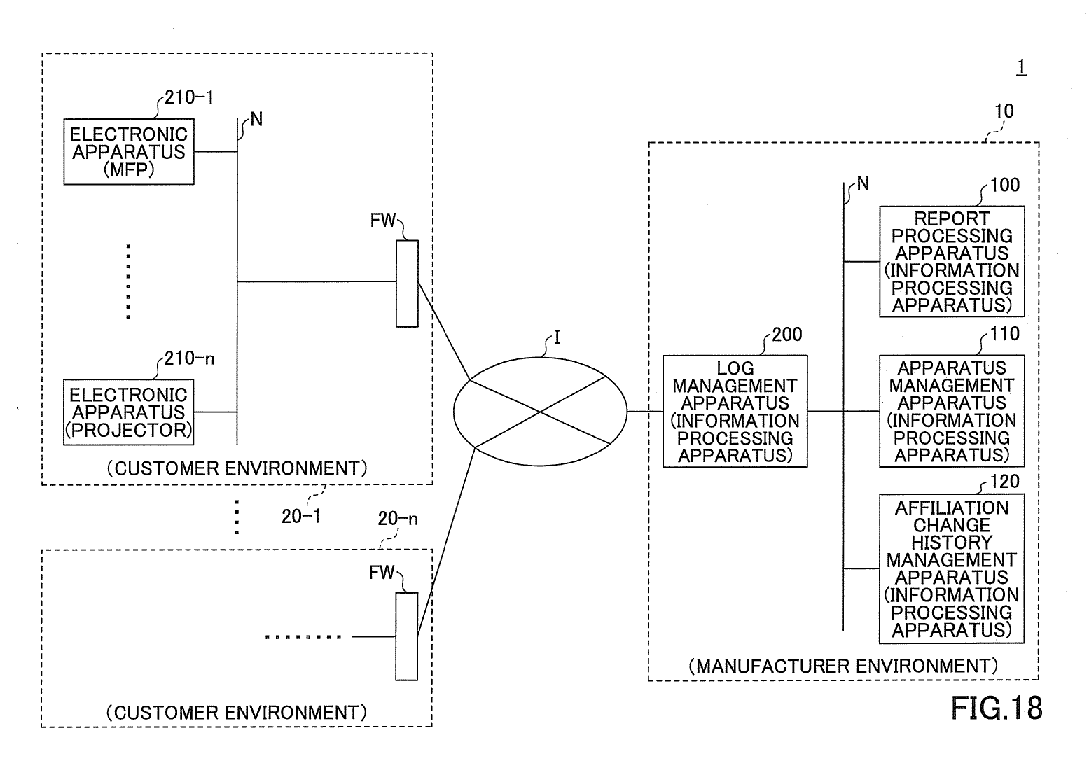

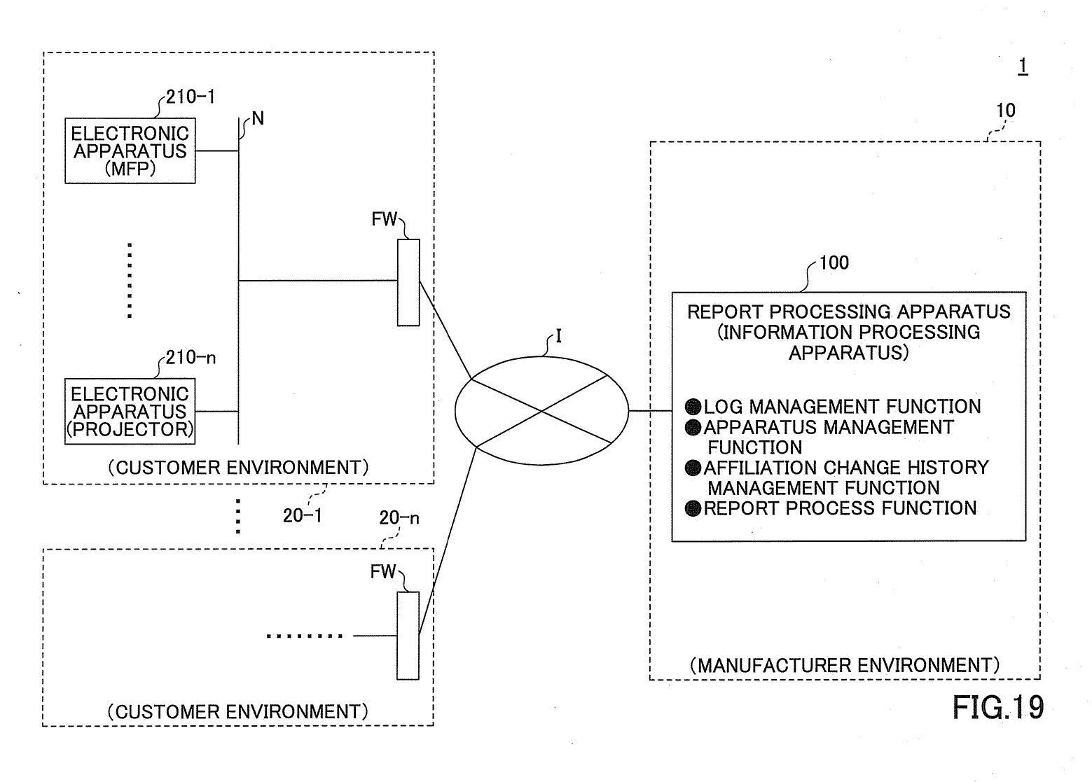

Moreover, although the information management apparatus 1 according to the above-mentioned embodiment has the structure illustrated in FIG. 1, the present invention is not limited to the structure illustrated in FIG. 1. For example, the structure such as illustrated in FIG. 18 or FIG. 19 may be used.

FIG. 18 and FIG. 19 are block diagrams of a first example and a second example of the structure of the information management system 1 according to the present variation.

FIG. 18 illustrates a system structure in which the log management apparatus 200 is connected to internal network N in the manufacturer environment 10. The internal network N of the customer environment 20 to which the electronic apparatus 210 is connected is connected to the external network I through a firewall FW. The log management apparatus 200 acquires the log information and the apparatus information from the electronic apparatus 210 through the external network I. The log management apparatus 200, the report process apparatus, the apparatus management apparatus 110 and the affiliation change history management apparatus 120 performs a collaborative operation in the same manner as the above-mentioned embodiment.

FIG. 19 illustrates a system structure in which the report process apparatus having the log management function, the apparatus management function and the affiliation change history management function is connected to the external network I. That is, FIG. 19 illustrates an example of a case where the functions of the log management apparatus 200, the apparatus management apparatus 110 and the affiliation change history management apparatus 120 are consolidated and mounted to the report process apparatus 100. The report process apparatus acquires the log information and the apparatus information from the electronic apparatus 210 by the log management function and the apparatus management function through the external network I. A collaborative operation of the report processing function, the log management function, the apparatus management function, and the affiliation change history management function in this case is the same as the apparatus collaborative operation explained in the above-mentioned embodiment.

Moreover, according to the report process apparatus 100 having the consolidated functions is capable of unifying the input functions provided to the apparatus information input reception part 11 and the history information input reception part 12. That is, the input functions provided in the apparatus information input reception part 11 and the history information input reception part 12 can be achieved by a single input reception part. In the report process apparatus 100, the information storage functions of the log management information retaining part, the apparatus management information retaining part 80, and the affiliation change history management information retaining part 70 can be unified. That is, the information storage functions of the log management information retaining part, the apparatus management information retaining part 80, and the affiliation change history management information retaining part 70 can be achieved by a single memory device. In such a case, sets of information is retained respectively by different memory areas, and managed for each kind of information.

The information management system 1 may provide an appropriate system structure according to contents of a contact agreed between a manufacture and a customer or a network environment between the manufacturer environment 10 and the customer environment 20.

Although the information management system, the information processing apparatus and the report processing method have been described according to the embodiments, the present invention is not limited to the specifically disclosed embodiments, and variations and modifications may be made without departing from the scope of the present invention.

The present invention is based on Japanese priority applications No. 2011-181566 filed on Aug. 23, 2011 and No. 2012-171957 filed on Aug. 2, 2012, the entire contents of which are hereby incorporated herein by reference.

What is claimed is:

1. An information management system comprising:
a first storage unit configured to retain history information, acquired from an electronic apparatus, indicating use history of said electronic apparatus;
a second storage unit configured to retain transition information indicating transition of an operation environment of said electronic apparatus in an installation site of said electronic apparatus; and
an information processing apparatus configured to output a report indicating a use status of said electronic apparatus,
wherein said first storage unit, said second storage unit and said information processing apparatus are mutually connected through a data transmission path, and
wherein said information processing apparatus includes:
an acquisition part configured to acquire said transition information from said second storage unit and acquire said history information from said first storage unit;
a creation part configured to create report data which aggregates apparatus use status for each affiliation area to which said electronic belongs during a designated report period based on said transition information and said history information; and
an output part configured to output said report data created by said creation part.

2. The information management system according to claim 1, wherein said acquisition part specifies transition information of date and time corresponding to said designated report period based on report period information indicating said designated report period by referring to date and time information contained in said transition information retained in said second storage unit, and said acquisition part acquires transition information of said electronic apparatus corresponding to a designated apparatus for reporting based on apparatus identification information to identify the designated apparatus for reporting by referring to apparatus identification information contained in the transition information specified.

3. The information management system according to claim 2, wherein said acquisition part specifies history information of date and time corresponding to said designated report period based on the report period information by referring to date and time information contained in said history information retained in said first storage unit, and said acquisition part acquires history information of said electronic apparatus corresponding to said designated apparatus for reporting based on the apparatus identification information of said designated apparatus for reporting by referring to apparatus identification information contained in the history information specified.

4. The information management system according to claim 3, wherein said creation part specifies an affiliation area to which said designated apparatus for reporting belongs during said designated report period based on the apparatus identification information, the date and time information and affiliate relation information indicating an affiliation area to which said electronic apparatus belongs contained in the acquired transition information and aggregation unit information indicating a designated aggregation unit, and said creation part aggregates use status of said designated apparatus for reporting for each affiliation area to which said designated apparatus belongs on an aggregation unit basis based on the apparatus identification information, the date and time information and use status information indicating use status of said electronic apparatus contained in the acquired history information and the specified section, and creates said report data based on a result of aggregation.

5. The information management system according to claim 4, wherein said creation part specifies the affiliation area to which said designated apparatus for reporting during said designated report period on a monthly basis when said aggregation unit information designates an aggregation on a monthly basis and said use status information indicates use status by an output amount of said electronic apparatus, and said creation part aggregates the output amount of said designated apparatus for reporting for each affiliation area during said designated report period based on the specified section.

6. The information management system according to claim 5, wherein said creation part calculates an output amount of the same designated report corresponding apparatus for each month during said designated report period, and accumulates and aggregates the calculated value for each affiliation area on monthly basis.

7. The information management system according to claim 1, wherein said information processing apparatus further includes an affiliation area specify part configured to specify an affiliation area to which said electronic apparatus belongs, and wherein said affiliation area specify part specifies the affiliation area corresponding to a network setting range to which a network setting value corresponds, based on a network setting value of said electronic apparatus by referring to affiliation management information in which the network setting range set to said electronic apparatus and an affiliation area corresponding to the network setting range are previously related.

8. The information management system according to claim 7, wherein said creation part creates the report data in which the apparatus use status is aggregated for each affiliation area to which said electronic apparatus belongs during said designated report period based on the affiliation area specified by said affiliation area specify part and based on said transition information and said history information.

9. An information processing apparatus configured to output information indicating use status of an apparatus, comprising:
an acquisition part configured to acquire transition information and history information, the transition information indicating a transition of an operating environment of said apparatus with respect contents specified in a contract, the history information indicating use history of said apparatus;
a creation part configured to create aggregation information indicating use status of said apparatus in a designated report period based on said transition information and said history information; and
an output part configured to output said aggregation information created by said creation part.

10. A non-transitory computer readable recording medium storing a report processing program causing a computer to perform as an information processing apparatus for outputting information indicating use status of an apparatus, the report processing program causing said computer to execute:
an acquisition procedure to acquire transition information and history information, the transition information indicating a transition of an operating environment of said apparatus with respect contents specified in a contract, the history information indicating use history of said apparatus;
a creation procedure to create aggregation information indicating use status of said apparatus in a designated report period based on said transition information and said history information; and
an output procedure to output said aggregation information created by said creation part.
